(19) United States
(12) Patent Application Publication
(10) Pub. No.: US 2025/0039871 A1
(43) Pub. Date: Jan. 30, 2025

(54) MANAGING SMALL DATA TRANSMISSION IN A DISTRIBUTED BASE STATION

(71) Applicant: GOOGLE LLC, Mountain View, CA (US)

(72) Inventors: Chih-Hsiang Wu, Taoyuan City (TW); Jing-Rong Hsieh, Taipei City (TW)

(21) Appl. No.: 18/716,349

(22) PCT Filed: Jan. 6, 2023
(86) PCT No.: PCT/US23/10263

§ 371 Date: Jun. 4, 2024

Related U.S. Application Data
(60) Provisional application No. 63/327,996, filed on Apr. 6, 2022.
(60) Provisional application No. 63/297,219, filed on Jan. 6, 2022.

(51) Int. Cl. H04W 72/1268; H04W 76/27

(52) U.S. Cl. CPC H04W 72/1268; H04W 76/27

(57) ABSTRACT

A method, implemented by a distributed unit (DU) of a base station that also includes a central unit (CU), of handling small data transmission (SDT) with a user equipment (UE), includes receiving, from the UE while the CE is in an inactive state, a first message including uplink data (304). The uplink data includes control plane or non-control plane information. The method also includes determining, based on a logical channel with which the uplink data is associated, whether to transmit the uplink data to a control plane of the CU (CU-CP) or a user plane of the CU (CU-UP) (306), and transmitting the uplink data to cither the CU-CP (308) or the CU-UP (320) in accordance with the determining.

### FIELD OF THE DISCLOSURE

This disclosure relates generally to wireless communications and, more particularly, to communication of uplink and/or downlink data using small data transmission (SDT) techniques at a user equipment (UE) and a distributed unit (DU) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state using RAN-level base station coordination and RAN-level paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating in the RRC_INACTIVE state (i.e., without requiring that the UE transition to the RRC_CONNECTED state).

SDT is enabled on a radio bearer basis, and is initiated by the UE only if less than a configured amount of uplink data awaits transmission across all radio bearers for which SDT is enabled, the downlink RSRP is above a configured threshold, and a valid SDT resource is available. An SDT procedure can be initiated by the UE with either a transmission over a random access channel (RACH), i.e., random access SDT (RA-SDT), or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in payload of a message A (MSGA) of a 2-step random access procedure. The network can then schedule subsequent uplink and/or downlink transmissions using dynamic uplink grants and downlink assignments, respectively, after completion of the random access procedure.

The CG-SDT can only be initiated with valid uplink (UL) timing alignment. The UL timing alignment is maintained by the UE based on a network-configured, SDT-specific timing alignment timer and DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG and the network can schedule subsequent uplink transmissions using dynamic grants or on the future CG resource occasions. During the CG-SDT, the downlink transmissions are scheduled using dynamic assignments. The UE can initiate subsequent uplink transmission only after reception of confirmation for the initial transmission from the network.

In some scenarios and implementations, the UE may connect to a 5G NR radio access network (NG-RAN) including base stations, where each of one or more base stations includes a central unit (CU) and at least one distributed unit (DU). However, it is not clear how a base station including a CU and a DU should handle the control plane data or the user plane data for the UE during the RA-SDT.

Currently specified techniques may result in network inefficiencies. For example, 3GPP specification 38.473 v16.7.0 section 8.3.1 specifies that, if the CellGroupConfig IE is included in the DU to CU RRC Information IE contained in the UE CONTEXT SETUP RESPONSE message, the gNB-CU shall perform RRC Reconfiguration or RRC Connection Resume as described in TS 38.331. In accordance with the 38.473 specification, the CellGroupConfig IE must be present in the DU to CU RRC Information IE and the DU to CU RRC Information IE must be present in the UE Context Setup Response. When the UE in the RRC_INACTIVE state initiates the RA-SDT with the CU, the CU shall perform the UE Context Setup procedure with the DU to establish a UE Context and resources for the DU to forward the received UL data to the CU. As a result of the UE Context Setup procedure, the CU receives a CellGroupConfig IE from the DU. In accordance with the 38.331 specification, the CellGroupConfig IE is contained in the RRCReconfiguration message and RRCResume message. Therefore, the CU can transmit an RRCResume message including the CellGroupConfig IE to the UE operating in the RRC_INACTIVE state. In response, the UE transitions to the RRC_CONNECTED state and transmits an RRCResumeComplete message to the CU via the DU. Thus, the CU is unable to maintain the UE in the inactive state, where the UE would be able to perform RA-SDT. This can result in less efficient radio resource and/or power usage. For example, to serve the UE operating in the RRC_CONNECTED state, the CU and DU use more radio resources and consume more power than would be needed to serve the UE operating in the RRC_INACTIVE state. Similarly, the UE operating in the RRC_CONNECTED state consumes more power to communicate with the DU and CU than the UE would consume in the RRC_INACTIVE state.

### SUMMARY

According to certain techniques of this disclosure, when a DU of a base station receives UL data from a UE in an inactive state, the DU forwards the UL data to either the control plane of the CU of the base station (CU-CP) or the user plane of the CU (CU-UP) based on the logical channel associated with the UL data. In some implementations, for example, the DU forwards the UL data to the CU-CP when the DU receives the UL data via a dedicated control channel (DCCH), and instead forwards the UL data to the CU-UP when the DU receives the UL data via a dedicated traffic channel (DTCH). The logical channel can be specified by a logical channel identifier (LCID) that the UE sends to the DU along with the UL data, for example. As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling Packet Data Convergence Protocol (PDCP), above the layer of the protocol for controlling MM, above the layer of the protocol for controlling SM, and/or above the layer of the protocol for controlling quality of service (QOS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message, for example. Further, the UE in some implementations applies SDT techniques only if the size of the data is below a certain (e.g., configured) threshold value.

If the CU does not have a context for the UE at the DU, and therefore cannot receive the UL data from the DU, the CU can in some implementations send a UE Context Request (e.g., UE Context Setup Request) message to the DU. For example, the UE may send the DU a UL MAC PDU containing both the UL data and a UL RRC message (e.g., a RRC resume request message), after which the DU forwards at least the UL RRC message to the CU-CP, the CU-CP responds by sending a UE Context Request message to the DU, and the DU responds by sending a UE Context Response (e.g., UE Context Setup Response) message to the CU-CP. In scenarios where the UL data is associated with a control channel (e.g., DCCH), the timing with which the DU forwards the UL data to the CU-CP can vary depending on the implementation. In a first implementation, for example, the DU forwards the UL data to the CU-CP before receiving a UE Context Request message from the CU-CP. In a second implementation, the DU forwards the UL data to the CU-CP after receiving the UE Context Request message from the CU-CP, in the UE Context Response message that the DU sends to the CU-CP. In a third implementation, the DU forwards the UL data to the CU-CP after both receiving the UE Context Request message from the CU-CP and sending the UE Context Response message to the CU-CP.

In some implementations, the CU causes the DU to perform either SDT or non-SDT with the UE by either indicating or not indicating, respectively, SDT operation in a message that the CU sends to the DU. For example, the CU-CP may indicate SDT by sending a UE Context Request message to the DU, or by sending the DU a message that includes an SDT indication.

In some implementations and scenarios, the CU can send the DU a message other than a UE Context Request message to cause the DU to discard UL data received from a UE in an inactive state. For example, the CU-CP may send the DU a RRC setup message when the CU-CP determines that no UE context for the UE has been found, or send the DU a RRC reject message when the base station encounters congestion or a resource shortage, etc., where the RRC setup, RRC reject, or other message causes the DU to discard the UL data.

In some implementations, and in scenarios where the CU sends the DU a UE Context Request message, the DU includes a CellGroupConfig information element in the UE Context Response message only if non-SDT is to be initiated (e.g., only if the CU or UE previously informed the DU of non-SDT or requested non-SDT), and otherwise omits the CellGroupConfig information element or, alternatively, sets the CellGroupConfig information element to zero length. In still other implementations, the DU always includes a CellGroupConfig information element in the UE Context Response message, but the CU can ignore or discard the CellGroupConfig information element when the CU has previously determined to perform SDT with the UE.

In one example, a method, implemented by a DU of a base station that also includes a CU, of handling SDT with a UE includes receiving, from the UE while the UE is in an inactive state, a first message including uplink data. The uplink data includes control plane or non-control plane information. The method also includes determining, based on a logical channel with which the uplink data is associated, whether to transmit the uplink data to a control plane of the CU (CU-CP) or a user plane of the CU (CU-UP), and transmitting the uplink data to either the CU-CP or the CU-UP in accordance with the determining.

In another example, a DU includes processing hardware and is configured to perform the above method.

### BRIEF DESCRIPTION OF THE DRAWINGS

FIG. 1A is a block diagram of an example system in which a base station and/or a user equipment (UE) can implement the techniques of this disclosure for managing small data transmission between the UE and a radio access network (RAN);

FIG. 1B is a block diagram of an example base station including a central unit (CU) and a distributed unit (DU) that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station;

FIG. 3A is a messaging diagram of an example procedure for performing random access channel based SDT (RACH-based SDT) when a radio connection between the UE and the base station is inactive;

FIG. 3B is a messaging diagram of another example procedure for performing RACH-based SDT when a radio connection between the UE and the base station is inactive;

FIG. 3C is a messaging diagram of yet another example procedure for performing RACH-based SDT when a radio connection between the UE and the base station is inactive;

FIG. 4A is a messaging diagram of an example procedure for performing RACH-based SDT when a radio connection between the UE and the base station is inactive and the CU-CP decides to bring the UE back to connected state after the SDT attempt;

FIG. 4B is a messaging diagram of another example procedure for performing RACH-based SDT when a radio connection between the UE and the base station is inactive and the CU-CP rejects the SDT attempt;

FIG. 5A is a flow diagram of an example method, which can be implemented in a base station DU, for receiving data from a UE and, based on the logical channel, sending the data to the CU via either a first or second protocol stack;

FIG. 5B is a flow diagram of an example method, which can be implemented in a base station DU, for receiving data from a UE and, based on the logical channel, sending the data to the CU via either a first or second protocol stack;

FIG. 5C is a flow diagram of an example method, which can be implemented in a base station DU, for receiving data from a UE and, based on whether the DU has a UE context, possibly establishing a UE context for a subsequent data transport procedure;

FIG. 6 is a flow diagram of an example method, which can be implemented in a base station DU, for receiving data from a UE and, based on the received CU-to-DU message, either transmitting the data or discarding the data;

FIG. 7 is a flow diagram of an example method, which can be implemented in a base station DU, for performing SDT with a UE in response to a received CU-to-DU message;

FIG. 8 is a flow diagram of an example method, which can be implemented in a base station DU, for performing SDT or non-SDT with a UE;

FIG. 9A is a flow diagram of an example method, which can be implemented in a base station DU, for determining whether to include a CellGroupConfig IE in a UE Context Setup Response message based on the purpose of the UE Context Setup message;

FIG. 9B is a flow diagram of an example method, which can be implemented in a base station DU, for determining whether to include a CellGroupConfig IE in a UE Context Setup Response message based on whether the UE requests or initiates SDT;

FIG. 9C is a flow diagram of an example method, which can be implemented in a base station DU, for determining whether to include a dummy or zero length CellGroupConfig IE in a UE Context Setup Response message based on whether UE requests or initiates SDT, or based on the purpose of the UE Context Setup message;

FIG. 10 is a flow diagram of an example method, which can be implemented in a base station CU-CP, for determining to perform SDT with a UE and configuring the DU to perform SDT with the UE;

FIG. 11 is a flow diagram of an example method, which can be implemented in a base station CU-CP, for receiving a SDT request from a UE and configuring the DU to perform SDT with the UE;

FIG. 12 is a flow diagram of an example method, which can be implemented in a base station CU-CP, for configuring the DU to perform SDT or non-SDT with the UE;

FIG. 13 is a flow diagram of an example method, which can be implemented in a base station CU-CP, for performing SDT with a UE and refraining from performing an RRC connection resume procedure with the UE;

FIG. 14 is a flow diagram of an example method, which can be implemented in a base station CU-CP, for performing SDT or non-SDT configuration with a UE.

### DETAILED DESCRIPTION OF THE DRAWINGS

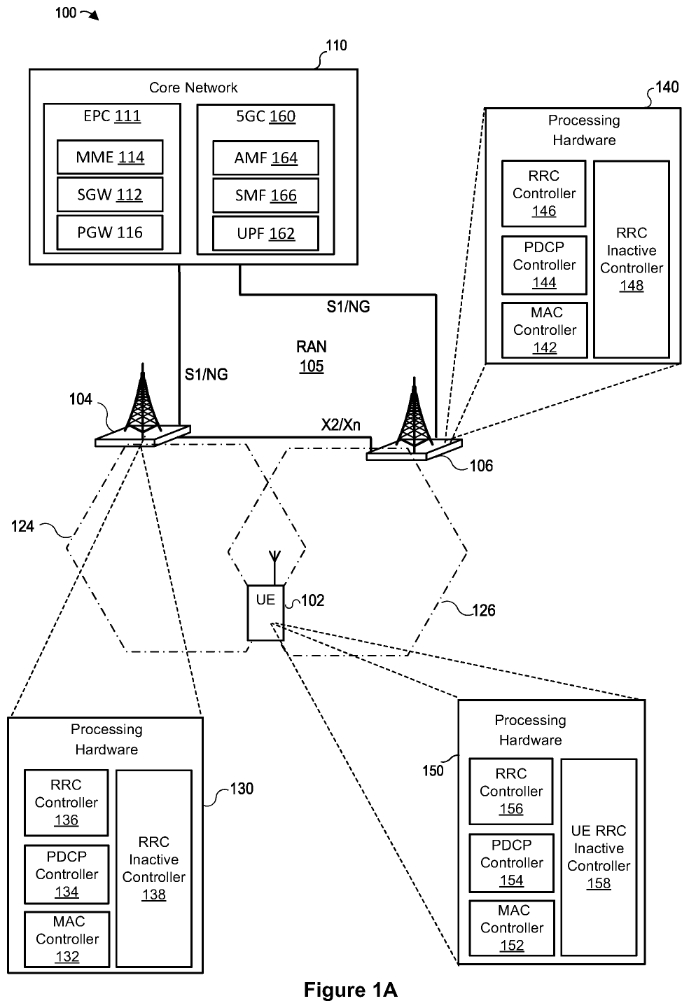

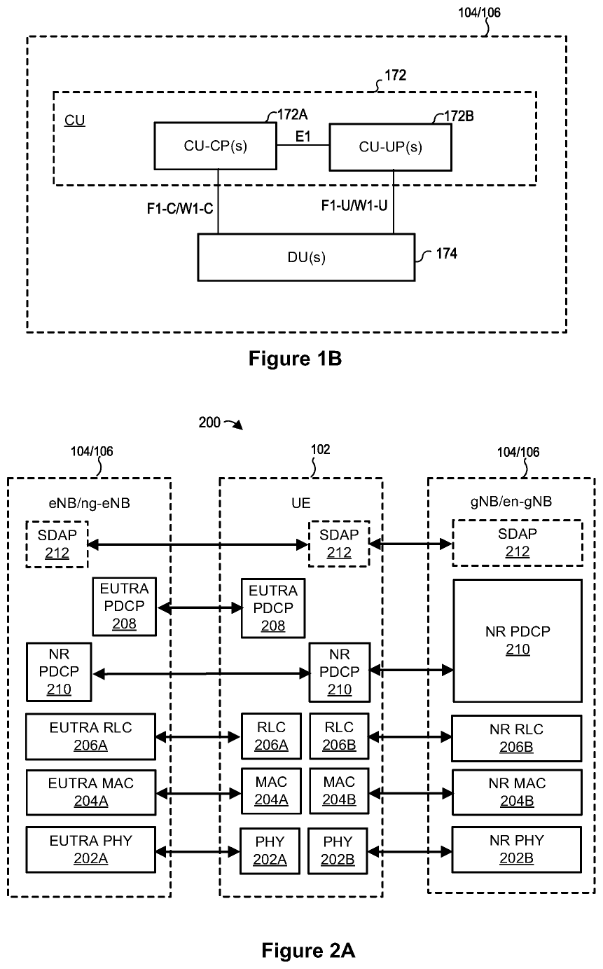

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core, in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 implement the techniques of this disclosure to communicate data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104 (either via the base station 106 or with the base station 104 directly) without transitioning to the RRC_CONNECTED state. In particular, the UE 102 and the base station 104 of the RAN 105 can communicate using small data transmission procedures, without the UE 102 transitioning to the RRC_CONNECTED state.

As a more specific example, the UE 102 in some cases transmits data in the uplink (UL) direction to the RAN 105 while the UE 102 operates in the RRC_INACTIVE or RRC_IDLE state.

After the UE 102 determines that data is available for uplink transmission while the UE 102 operates in the RRC_INACTIVE or RRC_IDLE state, the UE 102 can apply one or more security functions to the UL data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), a resume identity, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 can then transmit the security-protected packet to the RAN 105, while in the RRC_INACTIVE or RRC_IDLE state.

In some implementations, the data is an UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU, such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In such implementations, the UE 102 may omit a UE ID of the UE 102 from the UL MAC PDU. In yet other implementations, the UE 102 can include the UL PDCP PDU in a UL radio link control (RLC) PDU and then include the UL RLC PDU in the UL MAC PDU. In some implementations in which the UL MAC PDU includes the UL RRC message, the UE 102 generates an RRC MAC-I and includes the RRC MAC-I in the UL RRC message. For example, the RRC MAC-I may be a resumeMAC-I field, as specified in 3GPP specification 38.331. In other implementations, the UE can obtain the RRC MAC-I from the UL RRC message with an integrity key (e.g., K_{RRCint} key), an integrity protection algorithm, and the parameters COUNT (e.g., 32-bit, 64-bit or 128-bit value), BEARER (e.g., 5-bit value), and DIRECTION (e.g., 1-bit value).

In other implementations, the data is an UL SDU of the NAS. The UE 102 applies the security function to the SDU and includes the secured SDU in a first UL PDU such as a NAS PDU, which can be associated with the NAS layer. For example, the NAS layer can be an MM sublayer or an SM sublayer of 5G, Evolved Packet System (EPS), or 6G. The UE 102 can then include the UL NAS PDU in a second UL PDU, such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may omit an RRC MAC-I from the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 104 can retrieve the UE ID of the UE 102 from the UL RRC message and identify the base station 106 as the destination of the data in the first UL PDU, based on the determined UE ID. In such a scenario, the base station 106 can be referred to as the anchor base station, which sent the UE 102 into the inactive state and kept the full UE context information. In one example implementation, the base station 104 retrieves the first UL PDU from the second UL PDU and transmits the first UL PDU to the base station 106. The base station 106 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 106 derives at least one security key from UE context information of the UE 102. Then the base station 106 retrieves the data from the security-protected packet by using the at least one security key and transmits the data to the CN 110 or edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110 or edge server. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110 or edge server. However, if the base station 106 determines that the MAC-I is invalid, the base station 106 discards the packet.

In another implementation, the base station 104 retrieves the security-protected packet from the first UL PDU. The base station 104 performs a retrieve UE context procedure with the base station 106 to obtain UE context information for the UE 102 from the base station 106. The base station 104 derives at least one security key from the UE context information. Then the base station 104 retrieves the data from the security-protected packet by using the at least one security key and transmits the data to the CN 110 (e.g., UPF 162) or an edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 106 sends the data to the CN 110. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110. However, if the base station 104 determines that the MAC-I is invalid, the base station 104 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 that is currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU including the security-protected packet, and then includes the first DL PDU in a second DL PDU associated with the MAC layer, for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, then includes the DL RLC PDU in the DL MAC PDU, and then transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., an RRC release message or an RRC reconfiguration message) that the base station transmits to the UE 102 before transmitting the DCI and scrambled CRC, e.g., while the UE 102 was previously operating in the RRC_CONNECTED state, RRC_INACTIVE state, or RRC_IDLE state.

The UE 102 operating in the RRC_INACTIVE or RRC_IDLE state can receive the DCI and scrambled CRC on the PDCCH. The UE 102 then confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is an integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected—with encrypted data and an encrypted MAC-I—the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) from one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction in some scenarios, and receive UL PDCP PDUs in accordance with which the base station 104 can receive data in the uplink direction in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154, configured to transmit DL PDCP PDUs in accordance with which the base station 106 can transmit data in the downlink direction in some scenarios, and receive UL PDCP PDUs in accordance with which the base station 106 can receive data in the uplink direction in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or a Service Data Adaptation Protocol (SDAP) of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions. A bearer context is a block of information in a CU-UP node associated with one UE that is used for communication over the E1 interface. It may include the information about data radio bearers, PDU sessions and QoS flows associated with the UE. The block of information contains the necessary information required to maintain user-plane services for the UE.

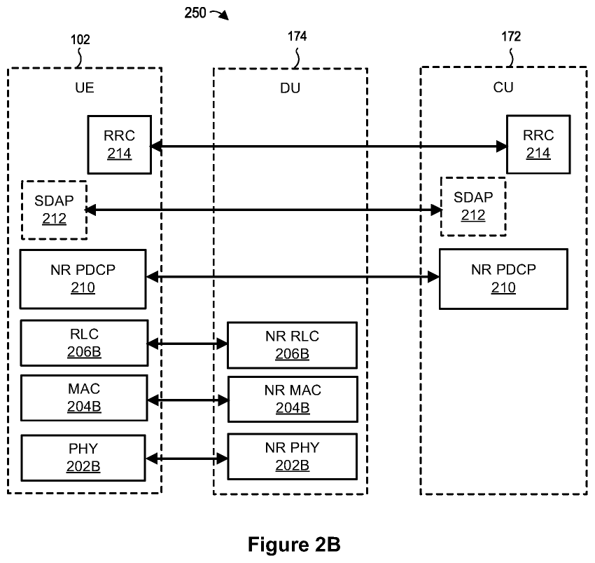

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUS, Internet Protocol (IP) packets, or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU 172 at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

The General Packet Radio System (GPRS) Tunneling Protocol for transmitting the user plane packets is specified in 3GPP TS 29.281. A GTP-U tunnel is identified in each node with a Tunnel Endpoint Identifier (TEID), an IP address and a UDP port number. The TEID (e.g., 4-octet) unambiguously identifies a tunnel endpoint in the receiving GTP-U protocol entity for a given UDP/IP endpoint. The receiving end side of a GTP tunnel locally assigns the TEID value the transmitting side has to use. The TEID values are exchanged between tunnel endpoints using control plane message. A GTP-U tunnel is necessary to enable forwarding packets between GTP-U entities.

GTP-U Tunnels are used to carry encapsulated T-PDUs and signaling messages between a given pair of GTP-U Tunnel Endpoints. The Tunnel Endpoint ID (TEID) which is present in the GTP header shall indicate the tunnel to which a particular Transport PDU (T-PDU) belongs. T-PDU is a user data packet, for example an IP datagram, sent between a UE and a network entity in an external packet data network. A T-PDU is the payload that is tunneled in the GTP-U tunnel. In this manner, packets are multiplexed and de-multiplexed by GTP-U between a given pair of Tunnel Endpoints. The TEID value to be used in the TEID field shall be negotiated for instance during the GTP-C Create PDP Context and the RAB assignment procedures that take place on the control plane. The TEID shall be used by the receiving entity to find the PDP context or bearer context. The TEID in the GTP-U header can be used to de-multiplex traffic incoming from remote tunnel endpoints so that the traffic is delivered to the User plane entities in a way that allows multiplexing of different users, different packet protocols, and different QoS levels.

The gNB-DU is responsible for the allocation of the F1-U DL GTP TEID for each data radio bearer. The gNB-CU-UP is responsible for the allocation of the F1-U UL GTP TEID for each data radio bearer. The gNB-CU-UP is responsible for the allocation of the S1-U DL GTP TEID for each E-RAB and the NG-U DL GTP TEID for each PDU Session. The gNB-CU-UP is responsible for the allocation of the X2-U DL/UL GTP TEID or the Xn-U DL/UL GTP TEID for each data radio bearer. For the Xn interface, the user plane packets conveyed by GTP-U may be PDCP PDUs (e.g., in case of dual connectivity), PDCP SDUs (e.g., in case of DRB level data forwarding), or SDAP SDUs (e.g., in PDU Session level data forwarding or QoS flow level data forwarding).

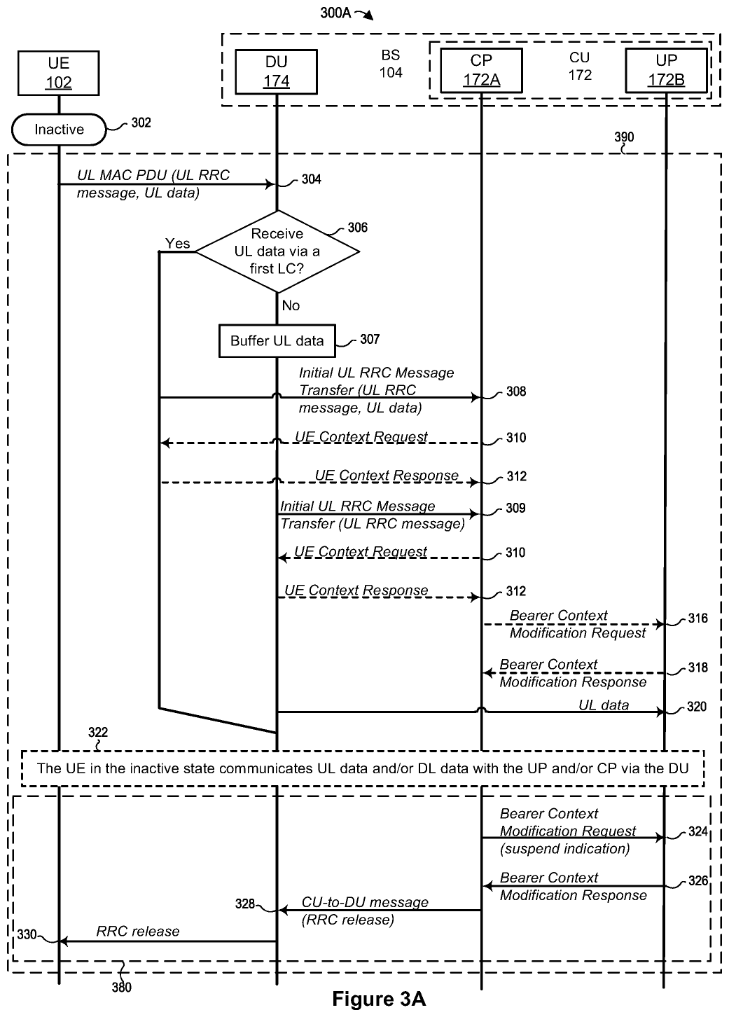

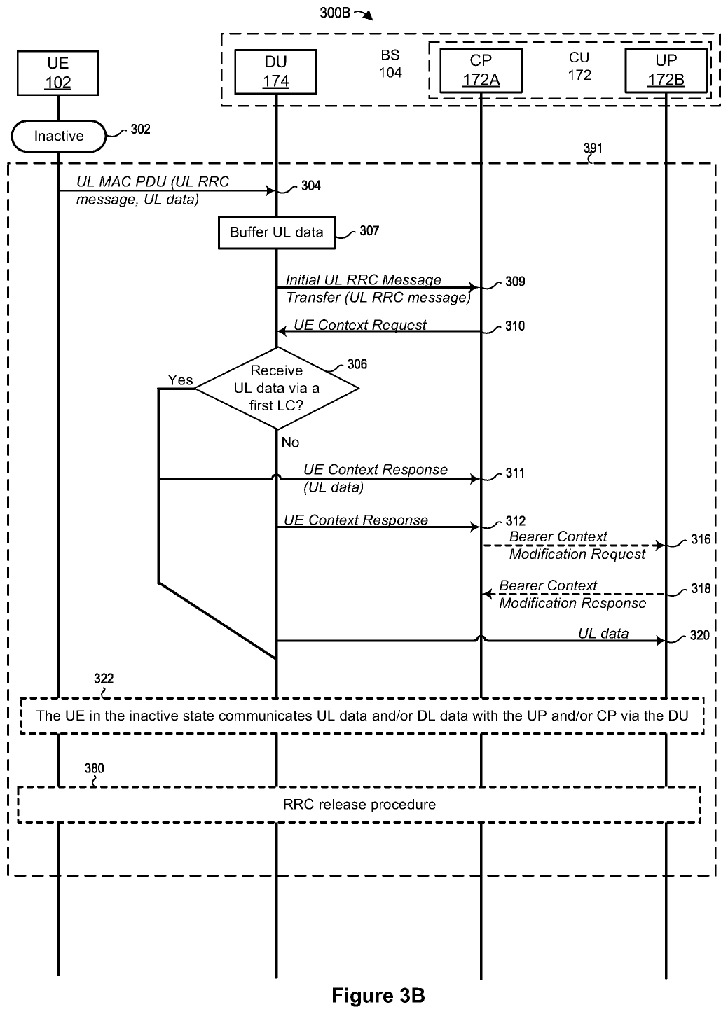

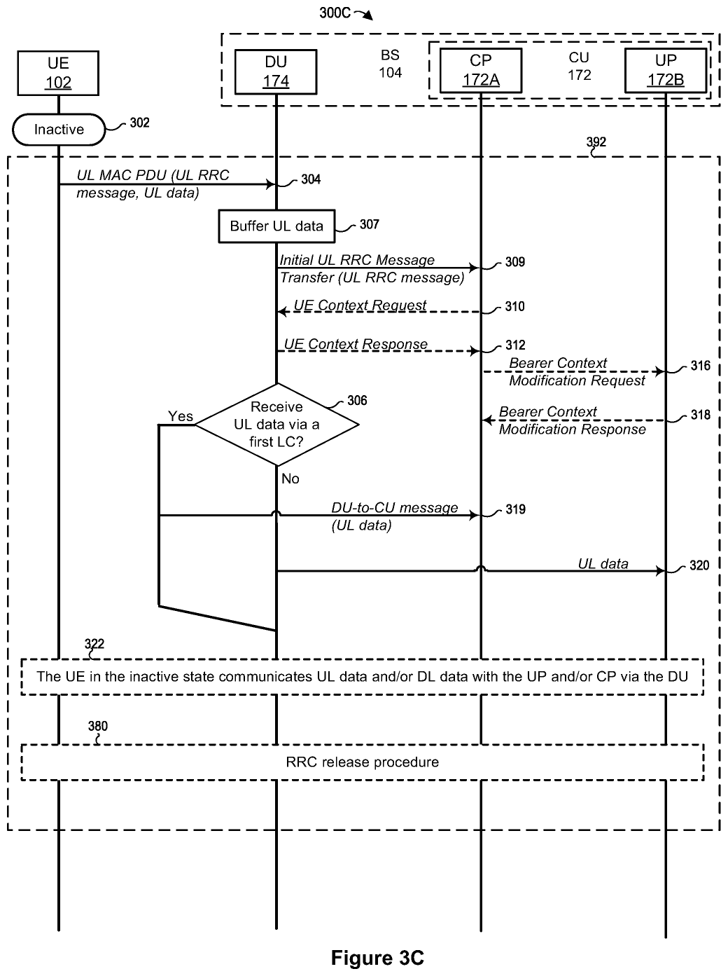

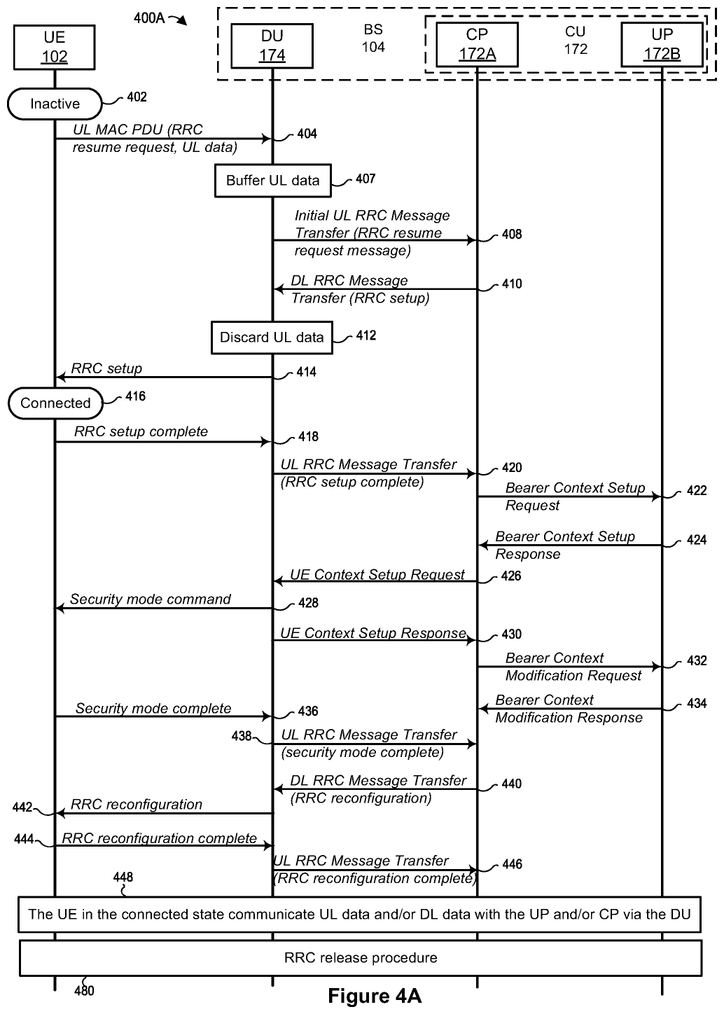

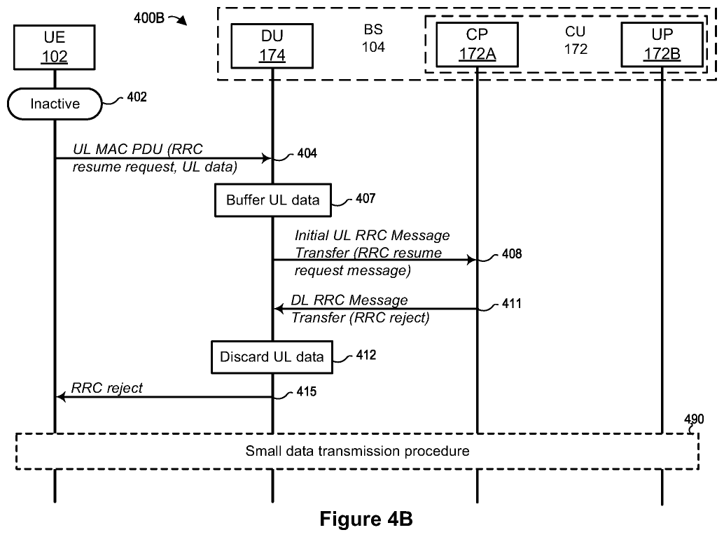

FIGS. 3A-3C and 4A-4B are messaging diagrams of example scenarios in which a UE (e.g., UE 102) and nodes of a RAN (e.g., RAN 105) implement the techniques of this disclosure for uplink and/or downlink small data transmission. Generally speaking, events in FIGS. 3A-3C and 4A-4B that are similar are labeled with similar reference numbers (e.g., event 302 in FIG. 3A is similar to event 302 in FIGS. 3B and 3C, events 402 in FIGS. 4A and 4B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

In some scenarios and implementations, and not shown in the figures, the UE 102 previously operated in a connected state with the RAN 105 (e.g., with the base station 104, base station 106, or another base station not shown in FIG. 1A), before transitioning to the inactive state. After a (first) certain period of data inactivity for the UE 102, the RAN 105 can determine that neither the RAN 105 nor the UE 102 has transmitted any data in the downlink direction or the uplink direction, respectively, during the (first) certain period. In response to the determination, the RAN 105 can transmit a first RRC release message (e.g., RRCRelease message or RRCConnectionRelease message) to the UE 102 and instruct the UE 102 to transition to the inactive state. The UE 102 transitions to the inactive state upon receiving the first RRC release message and operates 302 in the inactive state. The RAN 105 can assign UE identity/identifier (ID) (e.g., an I-RNTI or a resume ID) to the UE 102 and include the assigned value in the first RRC release message. After the UE 102 transitions to the inactive state, the UE 102 may perform one or more RAN notification area (RNA) updates with the CU-CP 172A via the DU 174 without state transitions, in some cases. In some implementations, the CU-CP 172A can include a security parameter (e.g., Next Hop Chaining Count) in the first RRC release message. The UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., K_{RRCint} key and/or the K_{UPint} key) and encryption key(s) (e.g., K_{RRCene} key and/or K_{UPene} key) from the base key. The CU-CP 172A derives security keys (i.e., same as the security keys derived by the UE 102) in a similar manner as the UE 102. The CU-CP 172A sends the integrity key (e.g., the K_{UPint} key) and/or encryption key (e.g., the K_{UPene} key) to the CU-UP 172B. The UE 102 and CU-UP 172B use the integrity key (e.g., the K_{UPint} key) and/or encryption key (e.g., the K_{UPene} key) in data communication. The UE 102 and CU-CP 172A use the integrity key (e.g., the K_{RRCint} key) and/or encryption key (e.g., the K_{RRCene} key) in communication of the first RRC release message. In the case of a CP-UP split, the CU-CP 172A configures UP ciphering and/or integrity protection over the bearer context setup/modification procedure, with the CU-UP 172B including the security algorithm and User Plane security keys (the encryption key and/or the integrity protection key). In some implementations, the UP ciphering algorithm may require input parameters including a cipher key KEY (e.g., 128-bit), a COUNT (e.g., 32-bit), a bearer identity BEARER (e.g., 5-bit), a transmission direction DIRECTION (e.g., 1-bit), and the required length of the keystream LENGTH. A keystream can be generated by the ciphering algorithm to encrypt the plaintext to generate the ciphertext and to recover/decrypt the ciphertext to the plaintext.

Referring first to FIG. 3A, in a scenario 300A, the UE 102 initially operates 302 in an inactive state (e.g., RRC_INACTIVE or RRC_IDLE) and the base station (BS) 104 includes a CU-CP 172A, a CU-UP 172B, and a DU 174. In some implementations, the UE 102 previously operated in a connected state with the BS 104 and, and the BS 104 caused the UE 102 to transition to the inactive state as described earlier.

At a later time, while the UE 102 operates 302 in the inactive state, the UE 102 transmits 304 an UL MAC PDU to the BS 104, and the BS 104 first receives the UL MAC PDU at the DU 174. The UL MAC PDU may include a UL RRC message and UL data. In some implementations, the UL RRC message can be an RRC resume request message (e.g., RRCResumeRequest message, RRCConnectionResumeRequest message, RRCResumeRequest1 message, or RRCConnectionResumeRequest/message). The UE 102 includes a logical channel identity (LCID) associated with the UL data in the UL MAC PDU. The UL data in some example scenarios is an Internet Protocol (IP) packet, an Ethernet packet, or an application packet. In other scenarios, the UL data is a PDU (e.g., RRC PDU, PDCP PDU or RLC PDU) that includes an RRC message, a NAS message, an IP packet, an Ethernet packet, or an application packet. Still further, the UL data in some scenarios can be an RRC PDU including a NAS PDU, such that the NAS PDU includes an IP packet, an Ethernet packet, or an application packet.

In some implementations, the UE 102 in the inactive state performs a random access procedure with the DU 174 to transmit 304 the UL MAC PDU. For example, the random access procedure can be a four-step random access procedure or a two-step random access procedure. In the case of the four-step random access procedure, the UE 102 transmits a random access preamble to the DU 174 and, in response, the DU 174 transmits to the UE 102 a random access response (RAR) including an uplink grant, and the UE 102 transmits 304 the UL MAC PDU in accordance with the uplink grant. The DU 174 receives 304 the UL MAC PDU in accordance with the uplink grant in the RAR. In the case of the two-step random access procedure, the UE 102 transmits 304 to the DU 174 a “message A” including a random access preamble and the UL MAC PDU in accordance with two-step random access configuration parameters. The UE 102 receives the two-step random access configuration parameters in system information broadcast by the DU 174 on the cell 124 before transmitting 304 the UL MAC PDU. The DU 174 receives 304 the UL MAC PDU in accordance with the two-step random access configuration parameters.

After receiving 304 the UL MAC PDU, the DU 174 determines 306 whether the UL data is received via a first logical channel (LC). In some implementations, a first LCID (i.e., value) can be reserved or predefined to identify the first LC. For example, the first LCID value can be a default value (e.g., “1” or “2”) specified in a 3GPP specification (e.g., 38.331). Thus, even though the DU 174 has not established a UE Context for the UE 102, the DU 174 can use the first LCID to determine 306 whether the LCID associated with the UL data has the same value as the first LCID or not. In some implementations, a first radio bearer (RB) ID (value) can be reserved or predefined and associated with the first LCID (value). In one implementation, the first RB ID value can be a default value (e.g., “1” or “2”) specified in a 3GPP specification (e.g., 38.331). Thus, even though the DU 174 has not established a UE Context for the UE 102, the DU 174 can determine the UL data is associated with the first RB (ID) based on the association between the first LCID and the first RB ID, in cases where the UL data is received via the first LC. In alternative implementations and/or scenarios, the first LC may correspond to any logical channel having a LCID value within a particular set of LCID values (e.g., any LCID value corresponding to a DCCH, if there are multiple DCCHs).

If the UL data is received via the first LC (i.e., the LCID associated with the UL data has the same value as the first LCID), the flow proceeds to event 308, where the DU 174 transmits 308 an Initial UL RRC Message Transfer message including the UL RRC message and the UL data to the CU-CP 172A. In some implementations, the DU 174 can include the first RB ID (or the first LCID) associated with the UL data in the Initial UL RRC Message Transfer message. The DU 174 may include the UL data in a container IE in the Initial UL RRC Message Transfer message. Conversely, if the UL data is received via an LC other than the first LC (e.g., the LCID associated with the UL data has a different value from the first LCID), the flow proceeds to event 307, where the DU 174 buffers 307 the UL data. The DU 174 then proceeds to transmit 309 an Initial UL RRC Message Transfer message including the UL RRC message to the CU-CP 172A. In this case, the DU 174 refrains from including or does not include the UL data in the Initial UL RRC Message Transfer message.

In some implementations, the Initial UL RRC Message Transfer message of the events 308 and 309 may include an SDT indication. The SDT indication may be an explicit indication in an information element (IE), field, or flag of the Initial UL RRC Message Transfer message, for example.

After receiving 308 or 309 the Initial UL RRC Message Transfer message, the CU-CP 172A in some implementations can send 310 a UE Context Request (e.g., UE Context Setup Request) message to the DU 174 to establish a UE Context of the UE 102 at the DU 174. In the UE Context Request (e.g., UE Context Setup Request) message, the CU-CP 172A can include one or more RB IDs and transport layer information for one or more GTP-U tunnels between the CU-UP 172B and DU 174, such that the DU 174 can transmit the UL data and/or subsequent UL data (e.g., in subsequent small data communication 322) associated with the RB(s) via the GTP-U tunnel(s) to the CU-UP 172B. The transport layer information can include a UL tunnel endpoint ID (TEID) and an IP address for each of the one or more GTP-U tunnels. The UL TEID(s) identifies an UL tunnel endpoint of the GTP-U tunnel. The RB ID(s) identifies RB(s) configured by the RAN 105 (e.g., the CU-CP 172A, another CU or another base station) for the UE 102 before the UE 102 transitions to the inactive state. Each of the RB ID(s) identifies a particular RB of the RB(s). Each of the GTP-U tunnel(s) is associated with a particular RB of the RB(s), and therefore each of the UL TEID(s) is associated with a particular RB ID. In some implementations, the UE context information can be originally stored at the CU-CP 172A if the base station 104 sent the UE 102 into the inactive state, or retrieved from another anchor base station (e.g., base station 106) via a Retrieve UE Context procedure. In further implementations, the anchor base station may decide not to relocate the full UE context information during the SDT operation, and only transfer partial UE context information for SDT (e.g., SDT DRB or SRB information including the RLC Bearer Configuration) via a Partial UE Context Transfer procedure. The SDT RLC Bearer Configuration(s) for the SDT SRB(s) and/or SDT DRB(s) are then sent to the DU 174. In such a case, the DRB IDs and transport layer information for one or more GTP-U tunnels between the CU-UP of the anchor base station and the DU 174 are also exchanged via the UE context setup procedure. Furthermore, the following Bearer Context management procedures (e.g., events 316-318 and 324-326) are instead performed by the CU-CP and the CU-UP of the anchor base station.

In response, the DU 174 can send 312 a UE Context Response (e.g., UE Context Setup Response) message to the CU 172. After receiving 304 the Initial UL RRC Message Transfer message, transmitting 310 the UE Context Setup (e.g., UE Context Setup Request) message, and/or receiving 312 the UE Context Response (e.g., UE Context Setup Response) message, the CU-CP 172A transmits 316 to the CU-UP 172B a Bearer Context Modification Request message to resume data transmission for the particular SDT RB(s) for the UE 102. In response, the CU-UP 172B resumes data transmission for the UE 102 and transmits 318 a Bearer Context Modification Response message to the CU-CP 172A. In some implementations, the DU 174 can include DU transport layer information for the one or more GTP-U tunnels in the UE Context Response (e.g., UE Context Setup Response) message. In turn, the CU-CP 172A can include the DU transport layer information in the Bearer Context Modification Request message. The DU transport layer information can include an IP address and/or a DL TEID for each of the one or more GTP-U tunnels. In cases where the DU 174 buffers 307 the UL data, and after receiving 310 the UE Context Request (e.g., UE Context Setup Request) message and/or transmitting 312 the UE Context Response (e.g., UE Context Setup Response) message, the DU 174 transmits 320 the UL data to the CU-UP 172B, e.g., via one of the one or more the GTP-U tunnels.

After transmitting 304 the UL data, the UE 102 in the inactive state can communicate 322 UL data and/or DL data with the CU-UP 172B and/or CU-CP 172A via the DU 174. After a certain period of data inactivity, the CU-CP 172A can determine that neither the CU 172 nor the UE 102 has transmitted any data in the downlink direction or the uplink direction, respectively, during the certain period. In response to the determination, the CU-CP 172A can determine to stop (or suspend) the SDT for the UE 102. Alternatively, the CU-CP 172A can determine to immediately stop the SDT for the UE 102 in response to determining that the UE 102 is in data inactivity, irrespective of any data transmission by the CU 172 in the downlink direction.

In response to or after determining to stop the SDT for the UE 102, the CU-CP 172A sends 324 to the CP-CU 172B a Bearer Context Modification Request message to suspend data transmission for the UE 102. In response, the CU-UP 172B suspends data transmission for the UE 102 and sends 326 a Bearer Context Modification Response message to the CU-CP 172A. In response to determining to transition the UE 102 to the inactive state, the CU-CP 172A can generate a RRC release message (e.g., RRCRelease message RRCConnectionRelease message) to transition the UE 102 to the inactive state. The CU-CP 172A can include a SDT configuration in the RRC release message to configure SDT for the UE 102 (e.g., to replace or modify a current SDT configuration for the UE 102). The CU-CP 172A then sends 328 to the DU 174 a CU-to-DU message (e.g., a UE Context Release Command) which includes the RRC release message. In turn, the DU 174 transmits 330 the RRC release message to the UE 102. The RRC release message instructs the UE 102 to transition to the inactive state (i.e., in this scenario, to remain in the inactive state). The UE 102 remains in the inactive state and stops the SDT upon receiving the RRC release message. The DU 174 can send a DU-to-CU message (e.g., a UE Context Release Complete message) to the CU-CP 172A in response to the CU-to-DU message of the event 328. In some implementations, the RRC release message is not generated by the CU-CP 172A, but is instead received from the anchor base station that kept the full UE context information. The RRC release message can be received via a Retrieve UE Context Failure message.

The events 324, 326, 328, 330 can be collectively referred to as an RRC release procedure 380. The events 304, 306, 307, 308, 309, 310, 312, 316, 318, 320, 322, 324, 326, 328, and 330 can be collectively referred to as a small data transmission (SDT) procedure 390.

Now referring to FIG. 3B, a scenario 300B is generally similar to the scenario 300A, except that the UL data is buffered at the DU 174 regardless of the logical channel associated with the UL data, and later transmitted to the CU-CP 172A or the CU-UP 172B based on the logical channel. The differences between the scenario 300B of FIG. 3B and the scenario 300A FIG. 3A are discussed below.

After receiving 304 the UL MAC PDU, the DU 174 buffers 307 the UL data and transmits 309 the Initial UL RRC Message Transfer message to the CU-CP 172A. After transmitting the Initial UL RRC Message Transfer message, the DU 174 makes the determination 306. In such cases, the DU 174 also buffers (e.g., at event 307) the LCID associated with the UL data, for use in making the later determination 306. In cases where the UL data is received via the first LC, the DU 174 transmits 311 a UE Context Response message including the UL data to the CU-CP 172A in response to the UE Context Request message 310. In cases where the UL data is received via another LC other than the first LC, the DU 174 transmits 310 the UE Context Response message to the CU-CP 172A and transmits 320 the UL data to the CU-UP 172B as described for FIG. 3A.

Alternatively, the DU 174 makes the determination 306 upon or after receiving 304 the UL MAC PDU, and stores a result of the determination 306. In this case, the DU 174 may or may not buffer the LCID associated with the UL data. Based on the stored result of the determination 306, the DU 174 can determine to transmit 311 the UE Context Response message including the UL data, or transmit 310 the UE Context Response message and transmit 320 the UL data to the CU-CP 172A and the CU-UP 172B, respectively, as described above.

The events 304, 307, 309, 310, 306, 311, 312, 316, 318, 320, 322, 324, 326, 328, and 330 can be collectively referred to as SDT procedure 391.

Referring next to FIG. 3C, a scenario 300C is generally similar to the scenario 300B, except that the DU 174 sends the UL data to the CU-CP 172A via a DU-to-CU message other than UE Context Response message, irrespective of the logical channel associated with the UL data. The differences between the scenario 300C of FIG. 3C and the scenarios 300A and 300B of FIGS. 3A and 3B are discussed below.

After receiving 304 the UL MAC PDU, the DU 174 buffers 307 the UL data and transmits 309 the Initial UL RRC Message Transfer message. After transmitting the Initial UL RRC Message Transfer message, the DU 174 makes the determination 306. In such cases, the DU 174 also buffers the LCID associated with the UL data, for use by the DU 174 when making the determination 306. In cases where the UL data is received via the first LC, the DU 174 transmits 319 a DU-to-CU message (e.g., UL RRC Message Transfer message) including the UL data to the CU-CP 172A. In cases where the UL data is received via an LC other than the first LC, the DU 174 transmits 320 the UL data to the CU-UP 172B as described for FIG. 3A.

Alternatively, the DU 174 makes the determination 306 upon or after receiving 304 the UL MAC PDU, and stores a result of the determination 306. In this case, the DU 174 may or may not buffer the LCID associated with the UL data. Based on the stored result of the determination 306, the DU 174 can determine to transmit 319 the DU-to-CU message (e.g., a UL RRC Message Transfer message) including the UL data to the CU-CP 172A or transmit 320 the UL data to the CU-UP 172B as described above.

The events 304, 307, 309, 310, 312, 316, 318, 306, 319, 320, 322, 324, 326, 328, and 330 can be collectively referred to as SDT procedure 392.

Referring next to FIG. 4A, a scenario 400A is similar to the scenarios 300A, 300B, and 300C, but the CU-CP decides to bring the UE back to the connected state after the SDT attempt. Events in this scenario similar to those discussed above are labeled with similar reference numbers, and the examples and implementations for FIGS. 3A-3C can apply to FIG. 4A (e.g., event 302 is similar to event 402, event 307 is similar to event 407, and event 380 is similar to event 480). The differences between the scenario 400A of FIG. 4A and the scenarios 300A, 300B, and 300C of FIGS. 3A, 3B and 3C are discussed below.

While the UE 102 operates 402 in the inactive state, the UE 102 transmits 404 a UL MAC PDU to the BS 104, with the BS 104 first receiving the UL MAC PDU at the DU 174. The UL MAC PDU includes an RRC resume request message (e.g., RRCResumeRequest message, RRCConnectionResumeRequest message, RRCResumeRequest1 message, or RRCConnectionResumeRequest message) and UL data. The DU 174 buffers 407 the UL data. The DU 174 transmits 408 an Initial UL RRC Message Transfer message including the RRC resume request message to the CU-CP 172A. The CU-CP 172A in response transmits 410 a DL RRC Message Transfer message including an RRC setup message (e.g., RRCSetup or RRCConnectionSetup message) to the DU 174. The DU 174 transmits 414 the RRC setup message to the UE 102. In response to the RRC setup message, the UE 102 transitions 416 to a connected state and transmits 418 an RRC setup complete message (e.g., RRCSetupComplete or RRCConnectionSetupComplete message) to the DU 174. The DU 174 transmits 420 a UL RRC Message Transfer message including the RRC setup complete message to the CU-CP 172A.

In some implementations, the DU 174 discards 412 the buffered UL data in response to or after receiving the DL RRC Message Transfer message. In other implementations, the DU 174 can start a timer when the DU 174 buffers 407 the UL data or transmits 408 the Initial UL RRC Message Transfer message. In cases where the DU 174 receives from the CU-CP 172A a UE Context Request for the UE 102 (e.g., event 310) after starting the timer and before the timer expires, the DU 174 stops the timer in response. If the timer expires without being stopped, however, the DU 174 discards 412 the UL data. If the DU 174 stops the timer before expiration, the DU 174 does not discard the UL data, and transmits the UL data to the CU 172 (e.g., to either the CU-CP 172A or CU-UP 172B based on the logical channel, as discussed above and in accordance with the implementation of one of FIGS. 3A-C). In some implementations or scenarios, the CU-CP 172A transmits the RRC setup message to the UE 102 via the DU 174 because the CU-CP 172A determines that no UE Context of the UE 102 has been found.

After receiving the RRC setup complete message, the CU-CP 172A transmits an Initial UE Message message to the CN 110 (e.g., AMF 164). In response, the CN 110 transmits an Initial Context Setup Request message to the CU-CP 172A. After receiving the RRC setup complete message and/or after receiving the Initial Context Setup Request message, the CU-CP 172A transmits 422 a Bearer Context Setup Request message to the CU-UP 172B to establish a bearer context for the UE 102. The CU-UP 172B transmits 424 a Bearer Context Setup Response message to the CU-CP 172B, including UL transport layer information for one or more GTP-U tunnels. The UL transport layer information can include a UL TEID and an IP address for each of the one or more GTP-U tunnels. After receiving Bearer Context Setup Response message, the CU-CP 172A transmits 426 a UE Context Setup Request message to establish a UE context in the DU 174 for the UE 102. In some implementations, the CU-CP 172A can include a security mode command (e.g., SecurityModeCommand) message in the UE Context Setup Request message. The DU 174 transmits 428 the security mode command message to the UE 102. In response to the UE Context Setup Request message, the DU 174 transmits 430 a UE Context Setup Response message to the CU-CP 172A. The CU-CP 172A transmits 432 a Bearer Context Modification Request message including DL transport layer information to the CU-UP 172B. The DL transport layer information can include a DL TEID and an IP address for each of the one or more GTP-U tunnels. The CU-UP 172B transmits 434 a Bearer Context Modification Response message to the CU-CP 172A. After receiving 436 the security mode complete message, the CU-CP 172A generates an RRC reconfiguration message (e.g., RRCReconfiguration or RRCConnectionReconfiguration message) and transmits 440 a DL RRC Message Transfer message including the RRC reconfiguration message to the DU 174. Events 436-438 and events 432-434 can occur with any timing relative to each other (e.g., in parallel), but both occur before event 440. The DU 174 transmits 442 the RRC reconfiguration message to the UE 102 to setup a SRB2 and/or one or more DRBs. In response, the UE 102 transmits 444 an RRC reconfiguration complete message (e.g., RRCReconfigurationComplete or RRCConnectionReconfiguration Complete message) to the DU 174. The DU 174 transmits 446 a UL RRC Message Transfer message including the RRC reconfiguration complete message to the CU-CP 172A. The CU-CP 172A transmits an Initial Context Setup Response message to the CN 110 in response to the Initial Context Setup Request message. In various implementations, the CU-CP 172A can transmit an Initial Context Setup Response message after or before receiving the RRC reconfiguration complete message.

After receiving 442 the RRC reconfiguration message and/or after transmitting 444 the RRC reconfiguration complete message, the UE 102 in the connected state communicates 448 UL data and/or DL data with the CU-UP 172B and/or CU-CP 172A via the DU 174. The BS 104 later performs a RRC release procedure 480 with the UE 102, similar to the procedure 380.

Referring next to FIG. 4B, a scenario 400B is similar to the scenarios 400A, 300A, 300B, and 300C, but the CU-CP 172A decides to reject the UE 102 after the SDT attempt. Events in scenario 400B similar to those discussed above are labeled with similar reference numbers and the examples and implementations for FIGS. 3A-3C can apply to FIG. 4A (e.g., event 302 is similar to event 402, event 307 is similar to event 407, and event 390, 391, or 392 is similar to event 490). The differences between the scenario 400B of FIG. 4B and the scenarios 400A, 300A, 300B, and 300C of FIGS. 4A, 3A, 3B, and 3C are discussed below.

In the scenario 400B, the CU-CP 172A transmits 411 a DL RRC Message Transfer message including a RRC reject message (e.g., an RRCReject message or an RRCConnectionReject message) to the DU 174 in response to the RRC resume request message. In turn, the DU 174 transmits 415 the RRC reject message to the UE 102. After receiving the RRC reject message, the UE 102 can perform a SDT procedure 490, similar to the SDT procedure 390 (or, alternatively, similar to SDT procedure 391 or 392).

In some implementations, the DU 174 discards 412 the buffered UL data after (e.g., in response to) receiving the DL RRC Message Transfer message. In other implementations, the DU 174 can start a timer when the DU 174 buffers 407 the UL data or transmits 408 the Initial UL RRC Message Transfer message. In cases where the DU 174 receives from the CU-CP 172A a UE Context Request for the UE 102 (e.g., event 310) after starting the timer and before the timer expires, the DU 174 stops the timer. If the timer expires, the DU 174 discards 412 the UL data. In some implementations or scenarios, the CU-CP 172A transmits the RRC setup message to the UE 102 via the DU 174 in response to the CU-CP 172A determining that no UE Context of the UE 102 has been found.

In some implementations or scenarios, the CU-CP 172A transmits the RRC reject message to the UE 102 via the DU 174 because the base station 104 encounters congestion or a resource shortage. In such cases, the CU-CP 172A can include a wait time (value) in the RRC reject message. The UE 102 can perform the SDT procedure 490 after the wait time elapses. In cases where the RRC reject message does not include a wait time (value), the UE 102 can perform the SDT procedure 490 immediately after receiving the RRC reject message or at a certain time (determined by the UE 102) after receiving the RRC reject message.

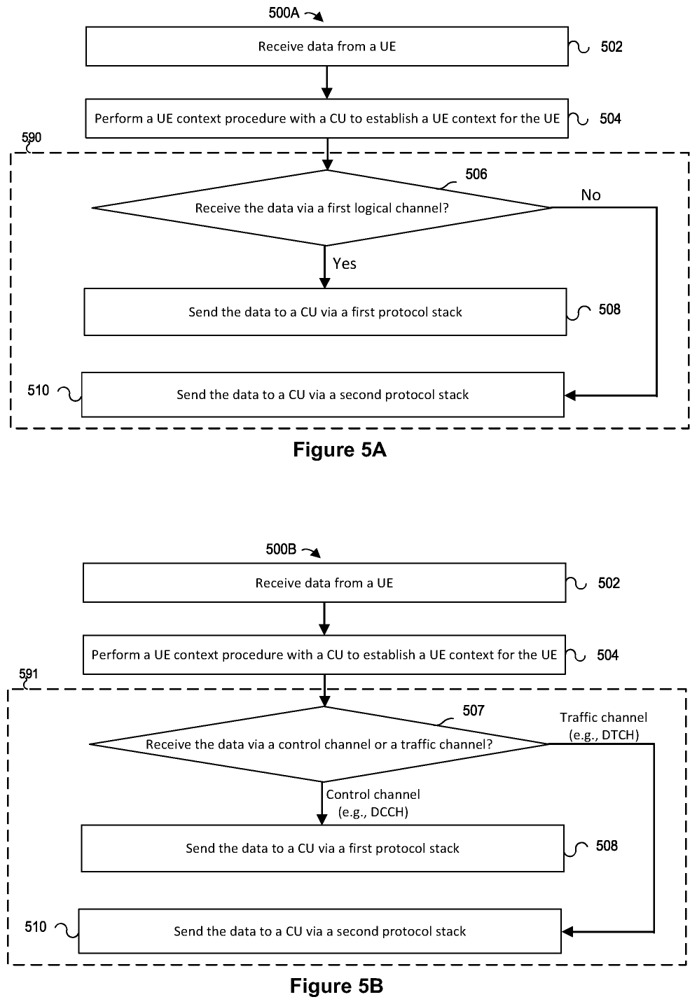

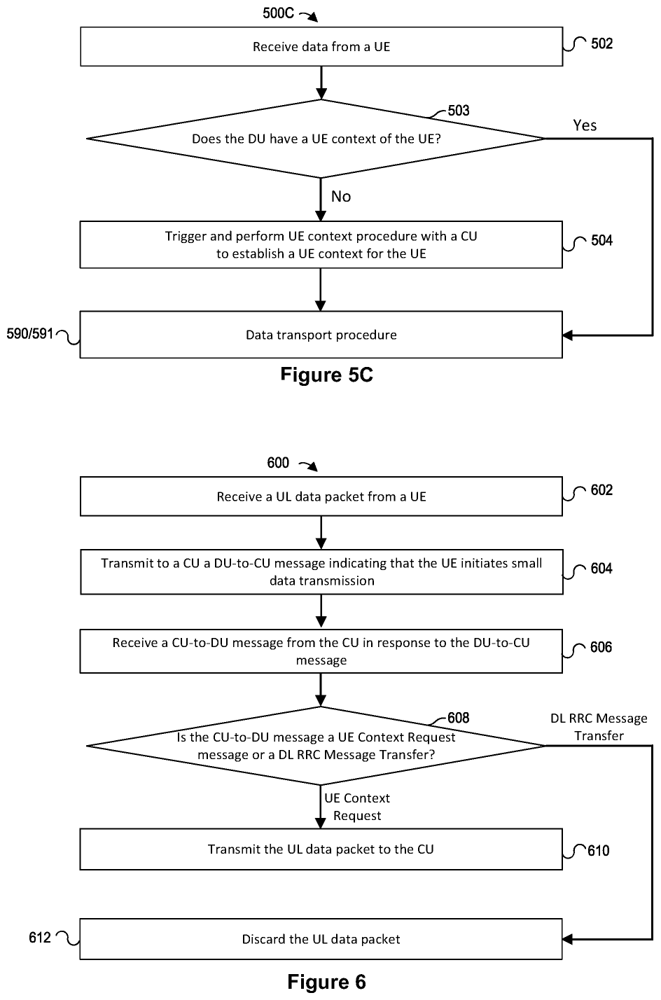

Next, several example methods that can be implemented in one or more base stations, DUs, CUs, or otherwise in a RAN to support small data transmissions in the inactive state with a UE, are discussed with reference to FIGS. 5-14.

FIG. 5A illustrates an example method 500A for receiving data from a UE (e.g., UE 102) and, depending on the logical channel, sending the data to the CU via a first or second protocol stack. The method 500A can be implemented in a base station DU 174 of FIGS. 3A-3C and 4A-4B, for example.

The method 500A begins at block 502, where the DU receives data from a UE (e.g., event 304 or 404). At block 504, the DU performs a UE context procedure with a CU (e.g., CU-CP 172A) to establish a UE context for the UE (e.g., events 310-312). The DU at block 506 determines whether the data is received via a first logical channel. If the data is received via the first logical channel, the flow proceeds to block 508 where the DU sends the data to a CU (e.g., CU-CP 172A) via a first protocol stack. On the contrary, if the data is NOT received via the first logical channel, the flow proceeds to block 510 where the DU sends the data to a CU (e.g., CU-UP 172B) via a second protocol stack. The blocks 506, 508, 510 can be collectively referred to as a data transport procedure 590.

In some implementations, the first protocol stack is the F1-C signaling bearer protocol stack as defined in 3GPP TS38.472, and the second protocol stack is the F1 Interface user plane protocol with Transport network layer for data streams over F1 as defined in 3GPP TS38.474.

FIG. 5B illustrates an example method 500B for receiving data from a UE (e.g., UE 102) and, depending on the logical channel, sending the data to the CU via a first or second protocol stack. The method 500B can be implemented in a base station DU 174 of FIGS. 3A-3C and 4A-4B, for example.

The method 500B begins at block 502, where the DU receives data from a UE (e.g., event 304 or 404). At block 504, the DU performs a UE context procedure with a CU (e.g., CU-CP 172A) to establish a UE context for the UE (e.g., events 310-312). The DU at block 507 determines whether the data is received via a control channel or a traffic channel. If the data is received via the control channel (e.g., DCCH), the flow proceeds to block 508 where the DU sends the data to a CU (e.g., CU-CP 172A) via a first protocol stack. On the contrary, if the data is received via the traffic channel (e.g., DTCH), the flow proceeds to block 510 where the DU sends the data to a CU (e.g., CU-UP 172B) via a second protocol stack. The blocks 507, 508, 510 can be collectively referred to as a data transport procedure 591.

In some implementations, the first protocol stack is the F1-C signaling bearer protocol stack as defined in 3GPP TS38.472, and the second protocol stack is the F1 Interface user plane protocol with Transport network layer for data streams over F1 as defined in 3GPP TS38.474.

FIG. 5C illustrates an example method 500C for receiving data from a UE (e.g., UE 102) and, depending on whether the DU has a UE context, possibly establishing a UE context for the following data transport procedure. The method 500C can be implemented in a base station DU 174 of FIGS. 3A-3C and 4A-4B, for example.

The method 500C begins at block 502, where the DU receives data from a UE (e.g., UE 102), such as at event 304 or 404. At block 503, the DU determines whether it has a UE context of the UE. If the DU has a UE context of the UE, the flow proceeds to a block where the DU performs the data transport procedure 590 or 591. On the contrary, if the DU does not have a UE context of the UE, the flow proceeds to block 504 where the DU triggers and performs a UE context procedure with a CU (e.g., CU-CP 172A) to establish a UE Context for the UE (e.g., event 308 for triggering the UE context procedure, and events 310-312 for performing the UE context procedure). After block 504, the flow proceeds to a block where the DU performs the data transport procedure 590 or 591.

FIG. 6 illustrates an example method 600 for receiving data from a UE (e.g., UE 102) and, depending on the type of a received CU-to-DU message, the DU either transmits the data or discards the data. The method 600 can be implemented in a base station DU 174 of FIGS. 3A-3C and 4A-4B, for example.

The method 600 begins at block 602, where the DU receives a UL data packet from a UE (e.g., UE 102), such as at event 304 or 404. The DU at block 604 transmits to a CU a DU-to-CU message indicating that the UE initiates small data transmission (e.g., event 309, 408). The DU at block 606 receives a CU-to-DU message from the CU in response to the DU-to-CU message (e.g., event 310, 410, 411). At block 608, the DU determines whether the CU-to-DU message is a UE Context Request message (e.g., UE Context Setup Request message) or a DL RRC Message Transfer message. If the CU-to-DU message is a UE Context Request message, the flow proceeds to block 610 where the DU transmits the UL data packet to the CU (e.g., event 320). On the contrary, if the CU-to-DU message is a DL RRC Message Transfer message, the flow proceeds to block 612 where the DU discards the UL data packet (e.g., event 412).

FIG. 7 illustrates an example method 700 for performing SDT with a UE (e.g., UE 102) in response to a received CU-to-DU message. The method 700 can be implemented in a base station DU 174 of FIGS. 3A-3C and 4A-4B, for example.

The method 700 begins at block 702, where the DU receives from a CU a CU-to-DU message indicating that the DU is to perform SDT with a UE (e.g., event 310). The DU at block 704 performs SDT with the UE in response to the CU-to-DU message.

In some implementations, the CU-to-DU message can include an indication to indicate that the DU is to perform small data transmission with the UE. In accordance with or in response to the indication, the DU performs small data transmission with the UE (e.g., event 322).

In some implementations, the DU can transmit a DU-to-CU message to the CU in response to the CU-to-DU message. In some implementations, the CU-to-DU message and the DU-to-CU message can be a UE Context Setup Request message and a UE Context Setup Response message, respectively. In other implementations, the CU-to-DU message and the DU-to-CU message can be a UE Context Modification Request message and a UE Context Modification Response message, respectively. In yet other implementations, the CU-to-DU message and the DU-to-CU message can be F1AP messages.

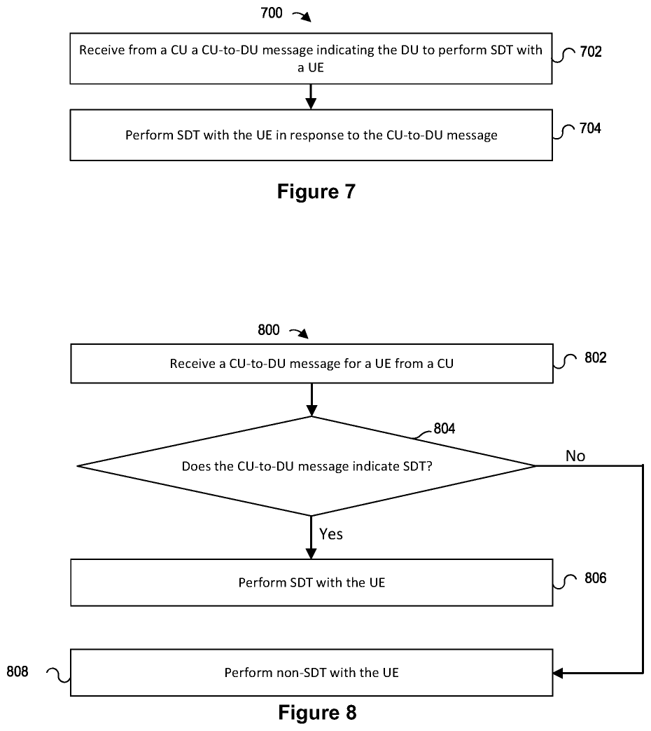

FIG. 8 illustrates an example method 800 for performing SDT or non-SDT with a UE (e.g., UE 102), which can be implemented in a base station DU 174 of FIGS. 3A-3C and 4A-4B, for example.

The method 800 begins at block 802 where the DU receives a CU-to-DU message for a UE from a CU (e.g., event 310 or 410). The DU at block 804 determines whether the CU-to-DU message indicates SDT (e.g., includes an explicit SDT indication, requests SDT, configures for SDT operation, or activates SDT). If the CU-to-DU message indicates SDT, the flow proceeds to block 806 where the DU performs SDT with the UE (e.g., event 322). If the CU-to-DU message does not indicate SDT, the flow proceeds to block 808 where the DU performs non-SDT with the UE (e.g., event 448).

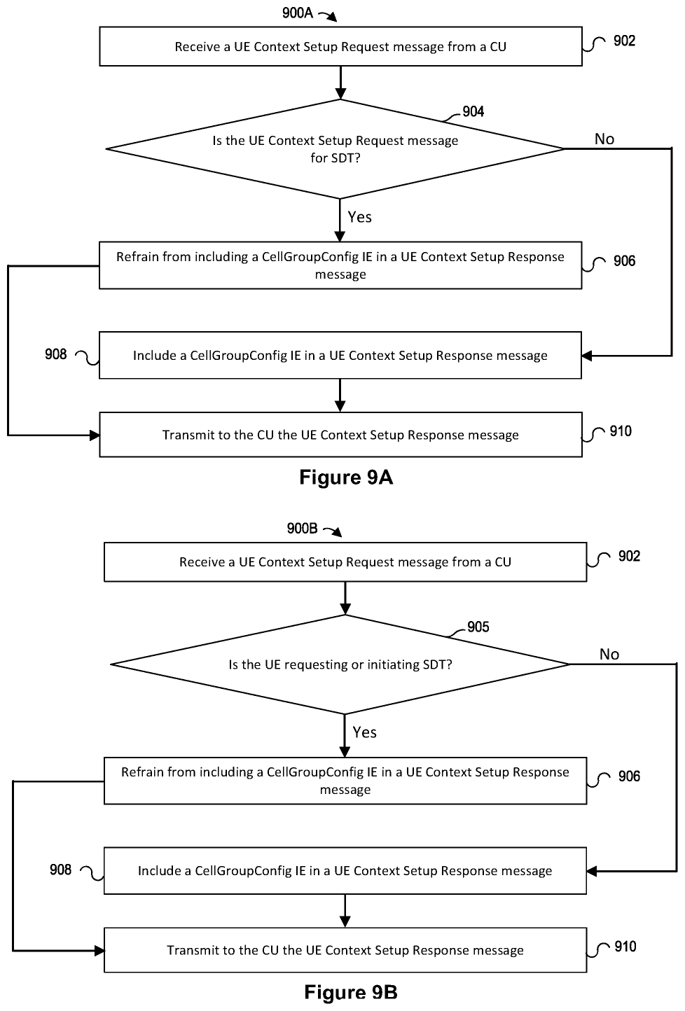

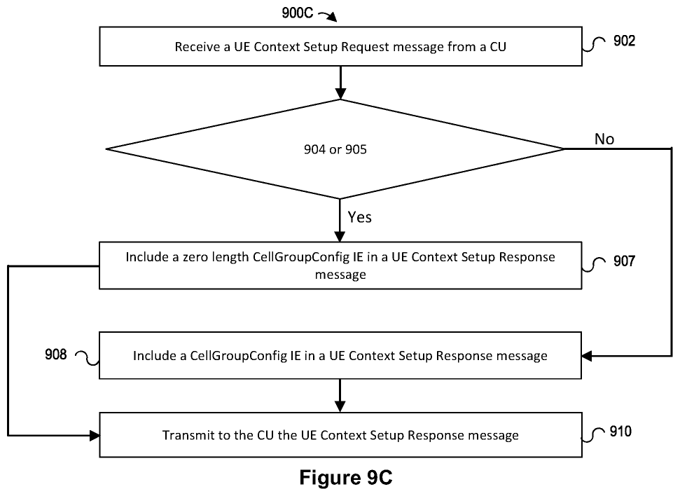

FIG. 9A illustrates an example method 900A for determining whether to include a CellGroupConfig IE in a UE Context Setup Response message, depending on the purpose of the UE Context Setup message. The method 900A can be implemented in a base station DU 174 of FIGS. 3A-3C and 4A-4B, for example.

The method 900A begins at block 902, where the DU receives a UE Context Setup Request message for a UE (e.g., UE 102) from a CU (see e.g., event 310). The DU at block 904 determines whether the UE Context Setup Request message is for SDT. If the UE Context Setup Request message is for SDT, the flow proceeds to block 906 where the DU refrains from including a CellGroupConfig IE in a UE Context Setup Response message. In some implementations, in the UE Context Setup Response message, the DU includes a DU to CU RRC Information IE that does not include the CellGroupConfig IE. The flow continues to block 910 where the DU transmits to the CU the UE Context Setup Response message (see e.g., event 311 or 312). If the UE Context Setup Request message is not for SDT, the flow proceeds to block 908 where the DU includes a CellGroupConfig IE in a UE Context Setup Response message. The flow continues to block 910 where the DU transmits to the CU the UE Context Setup Response message (see e.g., event 311 or 312).

In some implementations, the CellGroupConfig IE is as defined in the 3GPP TS 38.473 Section 9.3.1.26 (where the IE is intended to be encoded and processed by the network node(s) such as CU and/or DU). In other implementations, the CellGroupConfig IE is as defined in the 3GPP TS 38.331 Section 6.3.2 (where the IE is intended to be encoded and processed by the UE).

FIG. 9B illustrates an example method 900B for determining whether to include a CellGroupConfig IE in a UE Context Setup Response message depending on whether UE (e.g., UE 102) requests or initiates SDT. The method 900B can be implemented in a base station DU 174 of FIGS. 3A-3C and 4A-4B, for example.

The method 900B begins at block 902, where the DU receives a UE Context Setup Request message for a UE from a CU (see e.g., event 310). The DU at block 905 determines whether the UE requests or initiates SDT. If the UE requests or initiates SDT, the flow proceeds to block 906 where the DU refrains from including a CellGroupConfig IE in a UE Context Setup Response message. The flow continues to block 910 where the DU transmits to the CU the UE Context Setup Response message (see e.g., event 311 or 312). If the UE does not request or initiate SDT, the flow proceeds to block 908 where the DU includes a CellGroupConfig IE in a UE Context Setup Response message. The flow continues to block 910 where the DU transmits to the CU the UE Context Setup Response message (see e.g., event 311 or 312).

In some implementations, the CellGroupConfig IE is as defined in the 3GPP TS 38.473 Section 9.3.1.26 (where the IE is intended to be encoded and processed by the network node(s) such as CU and/or DU). In other implementations, the CellGroupConfig IE is as defined in the 3GPP TS 38.331 Section 6.3.2 (which is intended to be encoded and processed by the UE).

FIG. 9C illustrates an example method 900C for determining whether to include a dummy or zero length CellGroupConfig IE in a UE Context Setup Response message, depending on whether the UE (e.g., UE 102) requests or initiates SDT and/or depending on the purpose of the UE Context Setup message. The method 900C can be implemented in a base station DU 174 of FIGS. 3A-3C and 4A-4B, for example.

The method 900C begins at block 902, where the DU receives a UE Context Setup Request message for a UE from a CU (see e.g., event 310). The DU makes the determination as at block 904 of FIG. 9A, or as at block 905 of FIG. 9B. If the determination is “Yes” for block 904 or 905, the flow proceeds to block 907 where the DU includes a zero length CellGroupConfig IE in a UE Context Setup Response message. In some implementations, for the block 907, in the UE Context Setup Response message, the DU includes a DU to CU RRC Information IE, which further includes the CellGroupConfig IE but with the length of the CellGroupConfig IE being zero. The flow continues to block 910 where the DU transmits to the CU the UE Context Setup Response message (see e.g., events 311, 312). If the determination is “No” for block 904 or 905, the flow proceeds to block 908 where the DU includes a CellGroupConfig IE in a UE Context Setup Response message. The flow continues to block 910 where the DU transmits to the CU the UE Context Setup Response message (e.g., event 311, or 312).

In some implementations, the CellGroupConfig IE is as defined in the 3GPP TS 38.473 Section 9.3.1.26 (where the IE is intended to be encoded and processed by the network node(s) such as CU and/or DU). In other implementations, the CellGroupConfig IE is as defined in the 3GPP TS 38.331 Section 6.3.2 (where the IE is intended to be encoded and processed by the UE).

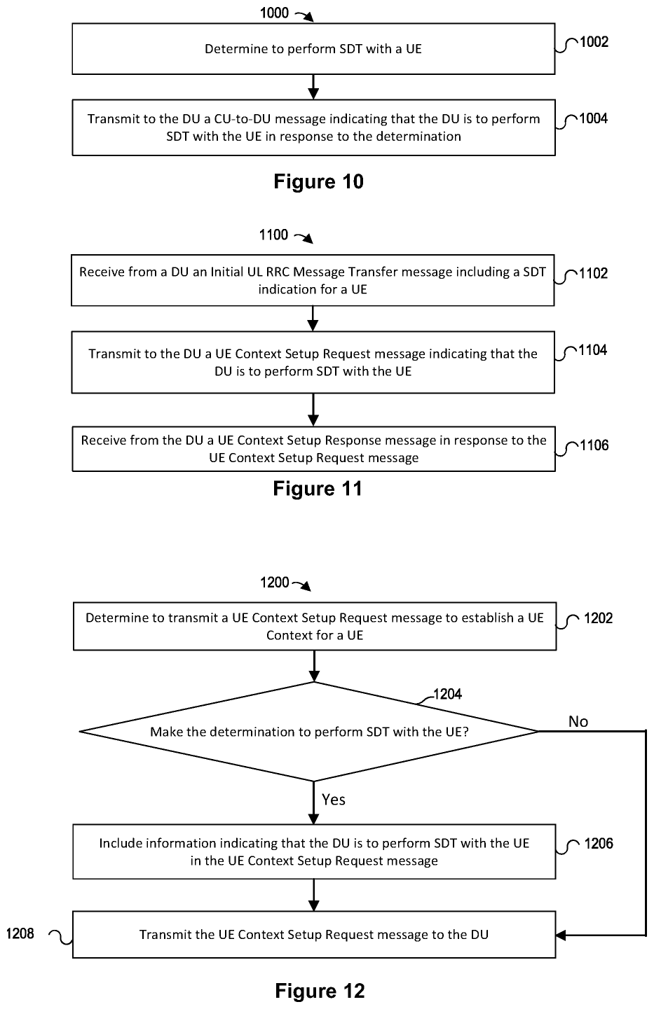

FIG. 10 illustrates an example method 1000 for determining to perform SDT with a UE (e.g., UE 102) and configuring the DU to perform SDT with the UE. The method 1000 can be implemented in a base station CU-CP 172A of FIGS. 3A-3C and 4A-4B, for example.

The method 1000 begins at block 1002, where the CU determines to perform SDT with a UE (e.g., in response to receiving the message at event 308 or 408, and/or based on one or more other factors). The CU at block 1004 transmits to the DU a CU-to-DU message indicating that the DU is to perform SDT with the UE in response to the determination (e.g., event 310). The CU-to-DU message may indicate SDT by including an explicit SDT indication, by requesting that the DU perform SDT with the UE, by configuring the DU to perform SDT with the UE, or by otherwise including information that enables the DU to perform SDT with the UE. Block 1004 may correspond to block 702, 802, or 902 of FIG. 7, 8, 9A, or 9C, for example, but from the perspective of the CU rather than the DU.

FIG. 11 illustrates an example method 1100 for receiving a SDT request from a UE (e.g., UE 102) and configuring the DU to perform SDT with the UE. The method 1100 can be implemented in a base station CU-CP 172A of FIGS. 3A-3C and 4A-4B, for example.

The method 1100 begins at block 1102, where the CU receives from a DU an Initial UL RRC Message Transfer message including a SDT indication for a UE (see e.g., events 308, 408). Based on the SDT indication, the CU determines to perform SDT with the UE, and in response (at block 1104) the CU transmits to the DU a UE Context Setup Request message including information indicating that the DU is to perform SDT with the UE (e.g., event 310). The CU-to-DU message may indicate SDT by including an explicit SDT indication, by requesting that the DU perform SDT with the UE, by configuring the DU to perform SDT with the UE, or by otherwise including information that enables the DU to perform SDT with the UE. Block 1104 may correspond to block 702, 802, or 902 of FIG. 7, 8, 9A, or 9C, for example, but from the perspective of the CU rather than the DU. At block 1106, the CU receives from the DU a UE Context Setup Response message in response to the UE Context Setup Request message (e.g., events 311, 312).

FIG. 12 illustrates an example method 1200 for configuring the DU to perform SDT or non-SDT with the UE (e.g., UE 102), which can be implemented in a base station CU-CP 172A of FIGS. 3A-3C and 4A-4B, for example.

The method 1200 begins at block 1202, where the CU determines to transmit a UE Context Setup Request message to establish a UE Context for a UE (see e.g., events 310, 426). The CU may make the determination at block 1202 in response to receiving the message at event 308 or 408, and/or based on one or more other factors. At block 1204, the CU checks whether it makes the determination to perform SDT with the UE. If the CU makes the determination to perform SDT with the UE, the flow proceeds to block 1206, where the CU includes information indicating that the DU is to perform SDT with the UE in the UE Context Setup Request message (e.g., event 310). The UE Context Setup Request message may indicate SDT by including an explicit SDT indication, by requesting that the DU perform SDT with the UE, by configuring the DU to perform SDT with the UE, or by otherwise including information that enables the DU to perform SDT with the UE. The flow continues to block 1208 where the CU transmits the UE Context Setup Request message to the DU (e.g., event 310). If the CU makes the determination to perform non-SDT with the UE, the flow proceeds to block 1208, where the CU transmits the UE Context Setup Request message to the DU (e.g., event 426). The DU performing SDT or non-SDT with the UE may be similar to event 322 or 448, respectively.

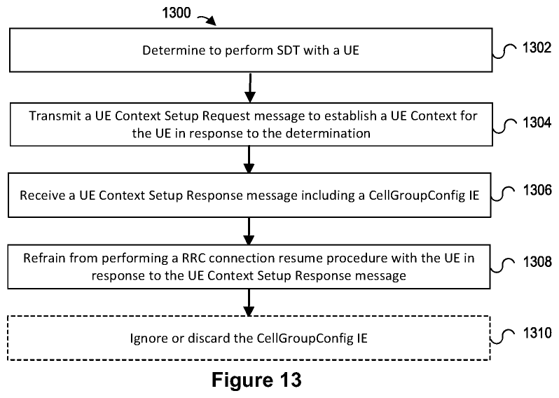

FIG. 13 illustrates an example method 1300 for performing SDT with a UE and refrain from performing an RRC connection resume procedure with the UE (e.g., UE 102), which can be implemented in a base station CU-CP 172A of FIGS. 3A-3C and 4A-4B, for example.

The method 1300 begins at block 1302, where the CU determines to perform SDT with a UE. The CU may make the determination at block 1302 in response to receiving the message at event 308 or 408, and/or based on one or more other factors. The CU at block 1304 transmits a UE Context Setup Request message to establish a UE Context for the UE in response to the determination (see e.g., event 310). The CU at block 1306 receives a UE Context Setup Response message including a CellGroupConfig IE (see e.g., event 312). The CU at block 1308 refrains from performing a RRC connection resume procedure with the UE in response to the UE Context Setup Response message. The CU at block 1310 can optionally ignore or discard the CellGroupConfig IE.

In some implementations, the CU at block 1308 refrains from performing a RRC reconfiguration procedure with the UE in response to the UE Context Setup Response message. In some implementations, ignoring or discarding the CellGroupConfig IE also means that the CU neither performs a RRC connection reconfiguration nor a RRC connection resume procedure.

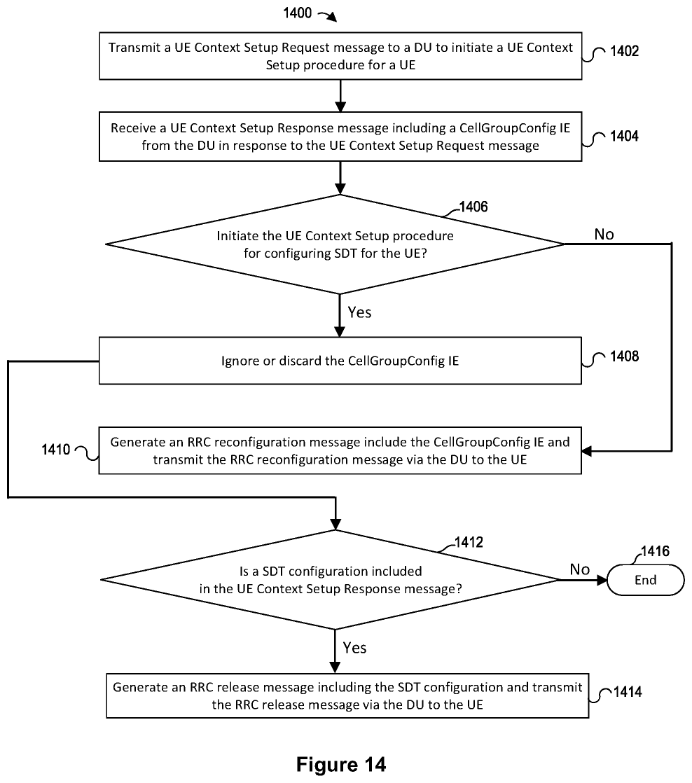

FIG. 14 illustrates an example method 1400 for performing SDT or non-SDT configuration with a UE (e.g., UE 102), which can be implemented in a base station CU-CP 172A of FIGS. 3A-3C and 4A-4B, for example.

The method 1400 begins at block 1402, where the CU transmits a UE Context Setup Request message to a DU to perform a UE Context Setup procedure for a UE (see e.g., event 310, 426). The CU at block 1404 receives a UE Context Setup Response message including a CellGroupConfig IE from the DU in response to the UE Context Setup Request message (see e.g., event 311, 312, 430). At block 1406, the CU determines whether the CU initiates the UE Context Setup procedure for SDT. If the CU initiates the UE Context Setup procedure for configuring SDT for the UE, the flow proceeds to block 1408 where the CU ignores or discards the CellGroupConfig IE. The flow continually proceeds to block 1412 where the CU further checks whether a SDT configuration is included in the UE Context Setup Response message. If the SDT configuration is included, the CU at block 1414 generates an RRC release message including the SDT configuration and transmit the RRC release message via the DU to the UE (see e.g., events 328, 380, 480). Otherwise, the flow ends at block 1416. If the CU initiates the UE Context Setup procedure not for configuring SDT at block 1406 (i.e., the CU initiates the UE Context Setup procedure for configuring non-SDT for the UE), the flow proceeds to block 1410 where the CU generates an RRC reconfiguration message include the CellGroupConfig IE and transmit the RRC reconfiguration message via the DU to the UE (see e.g., 440).

In some implementations, the SDT configuration can be a configuration for SDT or a configured grant configuration for SDT. For example, the SDT configuration can be or include a SDT-MAC-PHY-Config, SDT-ConfiguredGrantConfig, BWP-Uplink-Dedicated-SDT, BWP-Uplink-Dedicated-SDT, and/or BWP-Downlink-Dedicated-SDT.

While FIG. 14 relates to a UE Context Setup procedure, in other implementations and/or scenarios the method 1400 can involve a UE Context Modification procedure (e.g., with the CU transmitting a UE Context Modification Request message to the DU at block 1402, the CU receiving a UE Context Modification Response message from the DU at block 1404, and so on).

The following list of examples reflects a variety of the implementations explicitly contemplated by the present disclosure:

Example 1. A method, implemented by a distributed unit (DU) of a base station that also includes a central unit (CU), of handling small data transmission (SDT) with a user equipment (UE), the method comprising: receiving, from the UE while the UE is in an inactive state, a first message including uplink data; determining, based on a logical channel with which the uplink data is associated, whether to transmit the uplink data to a control plane of the CU (CU-CP) or a user plane of the CU (CU-UP); and transmitting the uplink data to either the CU-CP or the CU-UP in accordance with the determining.

Example 2. The method of example 1, wherein the determining includes: determining to transmit the uplink data to the CU-CP when the logical channel is a first logical channel, and to instead transmit the uplink data to the CU-UP when the logical channel is a second logical channel.

Example 3. The method of example 2, wherein the first logical channel is a dedicated control channel (DCCH) and the second logical channel is a dedicated traffic channel (DTCH).

Example 4. The method of example 2 or 3, wherein: determining whether to transmit the uplink data to the CU-CP or the CU-UP includes determining that the logical channel is the first logical channel; and the transmitting includes transmitting the uplink data to the CU-CP.

Example 5. The method of example 4, further comprising: receiving a UE context request message from the CU-CP after transmitting the uplink data to the CU-CP.

Example 6. The method of example 5, wherein: the first message includes the uplink data and an uplink radio resource control (RRC) message; and transmitting the uplink data to the CU-CP includes transmitting to the CU-CP a message that includes the uplink data and the uplink RRC message.

Example 7. The method of example 2 or 3, wherein: determining whether to transmit the uplink data to the CU-CP or the CU-UP includes determining that the logical channel is the first logical channel; and the transmitting includes transmitting the uplink data to the CU-CP.

Example 8. The method of example 7, further comprising: receiving a UE context request message from the CU-CP before transmitting the uplink data to the CU-CP.

Example 9. The method of example 8, wherein: the first message includes the uplink data and an uplink radio resource control (RRC) message; and the method further comprises transmitting the uplink RRC message to the CU-CP before receiving the UE context request message.

Example 10. The method of example 8 or 9, wherein transmitting the uplink data to the CU-CP includes transmitting, to the CU-UP, a UE context response message that includes the uplink data.

Example 11. The method of example 8 or 9, further comprising: transmitting a UE context response message to the CU-CP, wherein transmitting the uplink data to the CU-CP occurs after transmitting the UE context response message.

Example 12. The method of example 2 or 3, wherein determining whether to transmit the uplink data to the CU-CP or the CU-UP includes determining that the logical channel is the second logical channel, wherein the transmitting includes transmitting the uplink data to the CU-UP, and wherein the method further comprises: receiving a UE context request message from the CU-CP; and after receiving the UE context request message and before transmitting the uplink data to the CU-UP, transmitting a UE context response message to the CU-CP.

Example 13. The method of example 12, wherein: the first message includes the uplink data and an uplink radio resource control (RRC) message; and the method further comprises transmitting the uplink RRC message to the CU-CP before receiving the UE context request message.

Example 14. The method of any one of examples 1-13, wherein transmitting the uplink data occurs via an F1-C or F1-U interface.

Example 15. A method, implemented by a distributed unit (DU) of a base station that also includes a central unit (CU), of handling small data transmission (SDT) with a user equipment (UE), the method comprising: receiving, from the UE while the UE is in an inactive state, a first message including uplink data; determining, based on whether the DU receives a context request message for the UE from the CU, whether to discard the uplink data or instead transmit the uplink data to the CU; and either discarding or transmitting the uplink data in accordance with the determining.

Example 16. The method of example 15, further comprising: after receiving the first message, transmitting a DU-to-CU message to the CU; and after transmitting the DU-to-CU message, receiving a CU-to-DU message from the CU.

Example 17. The method of example 16, wherein: the CU-to-DU message is not a context request message for the UE; and the method comprises discarding the uplink data in response to receiving the CU-to-DU message that is not a context request message for the UE.

Example 18. The method of example 17, wherein the DU-to-CU message is an uplink radio resource control (RRC) message transfer message and the CU-to-DU message is a downlink RRC message transfer message.

Example 19. The method of example 18, wherein the downlink RRC message transfer message includes an RRC setup message or an RRC reject message.

Example 20. The method of example 19, wherein the downlink RRC message transfer message includes an RRC reject message, and wherein the RRC reject message includes a wait time value specifying a time the UE is to wait before performing a small data transmission procedure.

Example 21. The method of any one of examples 17-20, comprising: discarding the uplink data in response to receiving the CU-to-DU message.

Example 22. The method of example 16, wherein: the CU-to-DU message is a context request message for the UE; and the method comprises determining to transmit the uplink data to the CU and transmitting the uplink data in accordance with the determining.

Example 23. The method of example 22, wherein transmitting the uplink data in accordance with the determining includes: transmitting the uplink data to either a control plane of the CU (CU-CP) or a user plane of the CU (CU-UP) based on a logical channel with which the uplink data is associated.

Example 24. The method of example 15 or 16, further comprising: starting a timer, wherein the DU is configured to stop the timer in response to receiving a UE context request message for the UE before expiration of the timer, and wherein the determining includes either (i) determining to discard the uplink data in response to the expiration of the timer, or (ii) determining to transmit the uplink data to the CU in response to the DU stopping the timer.

Example 25. The method of any one of examples 15-24, wherein the first message includes the uplink data and a radio resource control (RRC) resume request message.

Example 26. A method, implemented by a distributed unit (DU) of a base station that also includes a central unit (CU), of handling small data transmission (SDT) with a user equipment (UE), the method comprising: receiving, from the CU, a CU-to-DU message; determining, based on the CU-to-DU message, whether to perform SDT or non-SDT with the UE; and performing either SDT or non-SDT with the UE in accordance with the determining.

Example 27. The method of example 26, wherein: the CU-to-DU message includes a SDT indication; the determining includes determining to perform SDT with the UE based on the SDT indication; and the performing includes performing SDT in accordance with the determining.

Example 28. The method of example 26, further comprising: transmitting or refraining from transmitting a cell group configuration information element to the CU based on whether the CU-to-DU message does not include or incudes, respectively, an SDT indication.

Example 29. The method of example 28, wherein: the CU-to-DU message is a UE context request message; and transmitting or refraining from transmitting the cell group configuration information element to the CU includes including or not including, respectively, the cell group configuration information element in a UE context response message.

Example 30. The method of example 28, wherein: the CU-to-DU message is a UE context request message; and transmitting or refraining from transmitting the cell group configuration information element to the CU includes setting a length of the cell group configuration information element to a non-zero value or to zero, respectively.

Example 31. The method of example 28, wherein: the CU-to-DU message is a UE context request message; and the method further comprises transmitting a UE context response message to the CU.

Example 32. The method of any one of examples 26-31, further comprising: receiving, from the UE while the UE is in an inactive state, a first message including uplink data and a radio resource control (RRC) message; and transmitting a DU-to-CU message to the CU, the DU-to-CU message including the RRC message, wherein receiving the CU-to-DU message is in response to transmitting the DU-to-CU message.

Example 33. The method of example 32, wherein the DU-to-CU message includes an SDT indication.

Example 34. A distributed unit (DU) of a base station that also includes a central unit (CU), the DU comprising processing hardware and being configured to perform the method of any one of examples 1-33.

Example 35. A method, implemented by a central unit (CU) of a base station that also includes a distributed unit (DU), of handling small data communications with a user equipment (UE), the method comprising: determining whether to perform small data transmission (SDT) or non-SDT with the UE; generating, in accordance with the determining, either a first CU-to-DU message indicating that the DU is to perform SDT with the UE or a second CU-to-DU message not indicating that the DU is to perform SDT with the UE; and causing the DU to perform either SDT or non-SDT with the UE, wherein the causing includes transmitting the first CU-to-DU message or the second CU-to-DU message, respectively, to the DU.

Example 36. The method of example 35, wherein: the determining includes determining to perform SDT with the UE; the generating includes generating the first CU-to-DU message; and the causing includes causing the DU to perform SDT with the UE by transmitting the first CU-to-DU message to the UE.

Example 37. The method of example 36, further comprising: receiving a DU-to-CU message from the DU, wherein determining to perform SDT with the UE is based on the DU-to-CU message.

Example 38. The method of example 37, wherein the DU-to-CU message is an initial uplink radio resource control (RRC) message transfer message.

Example 39. The method of any one of examples 36-38, wherein the first CU-to-DU message is a UE context request message.

Example 40. The method of example 39, further comprising: receiving a UE context response message from the DU, the UE context response message including a cell group configuration information element; and ignoring or discarding the cell group configuration information element.

Example 41. The method of example 39, further comprising: receiving a UE context response message from the DU; determining whether the UE context response message includes a SDT configuration; and based on whether the UE context response message includes the SDT configuration, either (i) generating a radio resource control (RRC) release message including the SDT configuration and transmitting the RRC release message to the UE via the DU, or (ii) refraining from generating the RRC release message.

Example 42. The method of example 39, further comprising: receiving a UE context response message from the DU; determining that the UE context response message includes a cell group configuration information element; and in response to receiving the UE context response message, refrain from performing a radio resource control (RRC) connection resume procedure with the UE.

Example 43. The method of any one of examples 36-38, wherein the first CU-to-DU message is an F1AP message.

Example 44. The method of example 35, wherein: the determining includes determining to perform non-SDT with the UE; the generating includes generating the second CU-to-DU message; and the causing includes causing the DU to perform non-SDT with the UE by transmitting the second CU-to-DU message to the UE.

Example 45. The method of example 44, wherein the second CU-to-DU message is a UE context request message.

Example 46. The method of example 45, further comprising: receiving, from the DU, a UE context response message including a cell group configuration information element; generating a radio resource control (RRC) reconfiguration message including the cell group configuration information element; and transmitting the RRC reconfiguration message to the UE via the DU.

Example 47. The method of any one of examples 44-46, wherein the second CU-to-DU message is an F1AP message.

Example 48. A central unit (CU) of a base station that also includes a distributed unit (DU), the CU comprising processing hardware and being configured to perform the method of any one of examples 35-47.

The following description may be applied to the description above.

In some implementations, a “message” (as the term is used above) can be replaced by “information element (IE),” and vice versa. In some implementations, an “IE” (as the term is used above) can be replaced by “field,” and vice versa. In some implementations, a “configuration” (as the term is used above) can be replaced by “configurations” or “configuration parameters,” and vice versa. In some implementations, “small data transmission” (as the term is used above) can be replaced by “early data transmission (EDT)” (and “SDT” can be replaced by “EDT”), and vice versa. In some implementations, “small data transmission” (as the term is used above) can be replaced by “small data communication,” and vice versa. Unless a more specific meaning is clear from the context of use, “small data transmission,” “SDT,” or “small data communication” may refer to small data transmission/communication in the uplink and/or downlink direction(s).

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, implemented by a distributed unit (DU) of a base station that also-includes a central unit (CU), of handling small data transmission (SDT) with a user equipment (UE), the method comprising:
receiving, from the UE while the UE is in an inactive state, a first message including uplink data, the uplink data including control plane or non-control plane information;
determining, based on a logical channel with which the uplink data is associated, whether to transmit the uplink data to a control plane of the CU (CU-CP) or a user plane of the CU (CU-UP); and
transmitting the uplink data to either the CU-CP or the CU-UP in accordance with the determining.

2. The method of claim 1, wherein the first message is an initial uplink radio resource control (RRC) message transfer message.

3. The method of claim 1, wherein the determining includes:
determining to transmit the uplink data to the CU-CP when the logical channel is a first logical channel, and to transmit the uplink data to the CU-UP when the logical channel is a second logical channel.

4. The method of claim 3, wherein the first logical channel is a dedicated control channel (DCCH) and the second logical channel is a dedicated traffic channel (DTCH).

5. The method of claim 3, wherein:
the determining whether to transmit the uplink data to the CU-CP or the CU-UP includes determining that the logical channel is the first logical channel; and
the transmitting includes transmitting the uplink data to the CU-CP.

6. The method of claim 5, further comprising:
receiving a UE context request message from the CU-CP after transmitting the uplink data to the CU-CP.

7. The method of claim 6, wherein:
the first message includes the uplink data and an uplink radio resource control (RRC) message; and
the transmitting the uplink data to the CU-CP includes transmitting to the CU-CP a message that includes the uplink data and the uplink RRC message.

8. The method of claim 3, wherein the determining whether to transmit the uplink data to the CU-CP or the CU-UP includes determining that the logical channel is the second logical channel, wherein the transmitting includes transmitting the uplink data to the CU-UP, and wherein the method further comprises:
receiving a UE context request message from the CU-CP; and
after receiving the UE context request message and before transmitting the uplink data to the CU-UP, transmitting a UE context response message to the CU-CP.

9. The method of claim 8, wherein:
the first message includes the uplink data and an uplink radio resource control (RRC) message; and
the method further comprises transmitting the uplink RRC message to the CU-CP before receiving the UE context request message.

10. The method of claim 1, wherein the transmitting the uplink data occurs via an F1-C or F1-U interface.

11. A distributed unit (DU) of a base station that also includes a central unit (CU), the DU comprising processing hardware and being configured to:
receive, from a user equipment (UE) while the UE is in an inactive state, a first message including uplink data, the uplink data including control plane or non-control plane information;
determine, based on a logical channel with which the uplink data is associated, whether to transmit the uplink data to a control plane of the CU (CU-CP) or a user plane of the CU (CU-UP); and
transmit the uplink data to either the CU-CP or the CU-UP in accordance with the determination.

12. The DU of claim 11, wherein the first message is an initial uplink radio resource control (RRC) message transfer message.

13. The DU of claim 11, wherein the DU is configured to determine to transmit the uplink data to the CU-CP when the logical channel is a first logical channel, and the DU is configured to determine to transmit the uplink data to the CU-UP when the logical channel is a second logical channel.

14. The DU of claim 13, wherein the first logical channel is a dedicated control channel (DCCH) and the second logical channel is a dedicated traffic channel (DTCH).

15. The DU of claim 13, wherein the DU is further configured to determine that the logical channel is the first logical channel, and wherein the uplink data is transmitted to the CU-CP.

16. The DU of claim 15, wherein the DU is further configured to receive a UE context request message from the CU-CP after transmission of the uplink data to the CU-CP.

17. The DU of claim 16, wherein the first message includes the uplink data and an uplink radio resource control (RRC) message, and wherein to transmit the uplink data to the CU-CP, the DU is configured to transmit to the CU-CP a message that includes the uplink data and the uplink RRC message.

18. The DU of claim 13, wherein to determine whether to transmit the uplink data to the CU-CP or the CU-UP, the DU is configured to determine that the logical channel is the second logical channel, wherein the uplink data is transmitted to the CU-UP, and wherein the DU is further configured to:
receive a UE context request message from the CU-CP; and
after reception of the UE context request message and before transmission of the uplink data to the CU-UP, transmit a UE context response message to the CU-CP.

19. The DU of claim 18, wherein:
the first message includes the uplink data and an uplink radio resource control (RRC) message; and
the uplink RRC message is transmitted to the CU-CP before reception of the UE context request message.

20. The DU of claim 11, wherein the uplink data is transmitted via an F1-C or F1-U interface.
